(19) United States
(12) Patent Application Publication
(10) Pub. No.: US 2013/0118847 A1
(43) Pub. Date: May 16, 2013

(54) MULTI-MODE SHOCK ASSEMBLY

(71) Applicants: Eli Krahenbuhl, Valencia, CA (US); Jonathan Quenzer, Marshall, WI (US); David Guzik, Madison, WI (US); Timothy Clavette, Sun Prairie, WI (US)

(72) Inventors: Eli Krahenbuhl, Valencia, CA (US); Jonathan Quenzer, Marshall, WI (US); David Guzik, Madison, WI (US); Timothy Clavette, Sun Prairie, WI (US)

(73) Assignee: Trek Bicycle Corp.

(21) Appl. No.: 13/526,372

(22) Filed: Jun. 18, 2012

Related U.S. Application Data
(60) Provisional application No. 61/497,593, filed on Jun. 16, 2011.

(51) Int. Cl. F16F 9/02; B62K 25/06

(52) U.S. Cl. CPC F16F 9/0209; B62K 25/06
USPC 188/313

(57) ABSTRACT

An apparatus including a first gas chamber, a second gas chamber, and a coupler. The first gas chamber can include a sleeve including a first mounting point and a cylinder including a second mounting point. In a first mode, the coupler can isolate the first gas chamber and the second gas chamber during a first translation range of the cylinder into the sleeve, and fluidly couple the first gas chamber to the second gas chamber during a second translation range of the cylinder into the sleeve. In a second mode, the coupler can fluidly couple the first gas chamber to the second gas chamber during at least the first translation range and the second translation range of the cylinder into the sleeve.

### CROSS-REFERENCE TO RELATED PATENT APPLICATIONS

This application claims the benefit of U.S. Provisional Application No. 61/497,593, filed Jun. 16, 2011, which is incorporated herein by reference in its entirety. This application is also related to U.S. application Ser. No. 12/109,453, filed Apr. 25, 2008; U.S. application Ser. No. 12/484,595, filed Jun. 15, 2009; and U.S. application Ser. No. 12/704,292, filed Feb. 11, 2010, all of which are incorporated herein by reference in their entireties.

### BACKGROUND

The present disclosure relates generally to the field of shocks and, in particular, to the field of multiple mode shocks.

A primary structural component of a conventional two-wheel bicycle can be the frame. On a conventional road bicycle, the frame is typically constructed from a set of tubular members assembled together to form the frame. For many bicycles, the frame is constructed from members commonly referred to as the top tube, down tube, seat tube, seat stays and chain stays, and those members are joined together at intersections commonly referred to as the head tube, seat post, bottom bracket and rear dropout. The top tube can extend from the head tube rearward to the seat tube. The head tube, sometimes referred to as the neck, can be a short tubular structural member at the upper forward portion of the bicycle which supports the handlebar and front steering fork, which has the front wheel on it. The down tube can extend downwardly and rearward from the head tube to the bottom bracket. The bottom bracket can include a cylindrical member for supporting the pedals and chain drive mechanism which can power the bicycle. The seat tube can extend from the bottom bracket upwardly to where it is joined to the rear end of the top tube. The seat tube can telescopically receive a seat post for supporting a seat or saddle for the bicycle rider to sit on.

The chain stays can extend rearward from the bottom bracket. The seat stays can extend downwardly and rearward from the top of the seat tube. The chain stays and seat stays can be joined together with a rear dropout for supporting the rear axle of the rear wheel. The front wheel assembly can be mounted between a pair of forks that are pivotably connected to the frame proximate the head tube. The foregoing description represents the construction of a conventional bicycle frame which does not possess a suspension having any shock absorbing characteristics.

The increased popularity in recent years of off-road cycling, particularly on mountains and cross-country, as well as an interest in reducing discomfort associated with rougher road riding, has made shock absorbing systems a desirable attribute in biking system. A bicycle with a properly designed suspension system can be capable of traveling over extremely bumpy, uneven terrain and up or down very steep inclines. Suspension bicycles can be less punishing, reduce fatigue, reduce the likelihood of rider injury, and can be much more comfortable to ride. For off-road cycling in particular, a suspension system can greatly increase the rider's ability to control the bicycle because the wheels remain in contact with the ground as they ride over rocks and bumps in the terrain instead of being bounced into the air as occurs on conventional non-suspension bicycles.

Over the last several years, the number of bicycles now equipped with suspension systems has dramatically increased. In fact, many bicycles are now fully suspended, meaning that the bicycle has both a front and rear wheel suspension systems. Front suspensions were the first to become popular. Designed to remove the pounding to the bicycle front end, the front suspension is simpler to implement than a rear suspension. In addition, a front suspension fork can be easy to retrofit onto an older model bicycle. On the other hand, a rear suspension can increase traction and assist in cornering and balance the ride.

During cycling, as the bicycle moves along a desired path, discontinuities of the terrain are communicated to the assembly of the bicycle and ultimately to the rider. Although such discontinuities are generally negligible for cyclists operating on paved surfaces, riders venturing from the beaten path frequently encounter such terrain. With the proliferation of mountain biking, many riders seek the more treacherous trail. Technology has developed to assist such adventurous riders in conquering the road less traveled. Wheel suspension systems are one such feature.

Even though suspension features have proliferated in bicycle constructions, the performance of the suspension as well as the structure of the bicycle are often limited to or must be tailored to cooperate with the structure and operation of the shock. Commonly, both ends of the shock are secured to the bicycle between movable frame members where movement is intended to be arrested, dampened, or otherwise altered. The shock is often connected between a portion of the frame and structure proximate an axle of an associated wheel to provide a desired travel distance and/or resistance to the relative displacement of the structures secured to the generally opposite ends of the shock. The incorporation of the shock member in such a manner generally determines the motion performance of the shock adapted structure.

Commonly, an eyelet is positioned at each end of the shock and cooperates with a pass through fastener that secures the respective ends of the shock to the desired structure of the bicycle. Other shock systems utilize a clamp that engages along an outside diameter of the damper body. This association of the structure of the bicycle and the structure of the shock generally defines the shock that can be used with any given bicycle as well as the shock performance that can be provided. To alter the shock performance of a particular bicycle commonly requires changing the shock provided the newly desired shock has a mount configuration and translation distance that correlates to the structure of the bicycle. Such a requirement increases the cost associated with performance of suspension features of any bicycle.

The rider must commonly acquire either various shocks assemblies or various parts of a shock assembly to alter the performance of suspension features of a particular bicycle. Further, if a rider has multiple bicycles, as many competitive riders do, acquiring the components to alter the performance of the suspension of a number of bicycles can be particularly expensive. With respect to shock manufacturing, as the structure of bicycle suspension features changes, shocks must be restructured to cooperate with the new bicycle structure. Shock design, construction, and assembly can become particularly costly in those instances where a variety of different shocks having different shock performance characteristics must be provided for one particular bicycle to satisfy individual rider preferences. Satisfying individual rider preferences across the various product platforms of various bicycle manufactures requires providing uncountable specific shock constructions.

Therefore, there is a need for a shock system that can be configured to cooperate with a variety of bicycle structures. There is a further need for a shock system that can provide a variety of shock performances without otherwise interfering with the mounting of the shock to the bicycle. There is a further need for a shock system that can be quickly and efficiently configured to cooperate with a bicycle.

In addition, there also is a desire for a shock system that provides better performance during climbs. When climbing on a full suspension mountain bicycle, rider weight is typically biased toward the rear of the bicycle. This creates increased displacement of the rear shock of the bicycle as well as extension of the front steering fork; both of which can degrade performance of the bicycle. While numerous efforts have been made to provide adjustable travel forks and rear shock features to aid in climbing, there remains a need for a shock system that accommodates the rearward displacement of the rider during climbs.

Furthermore, there remains a need for a bicycle seat post that can be adjusted during a ride without requiring the weight of the rider to lower the seat post. For example, during a descent from a climb, it is often desirable to lower the saddle, which is supported by the seat post, so that the rider can extend rearward to a more over-the-rear-wheel position and to a relatively lower body position to improve aerodynamics during the descent without sacrificing bicycle control. While seat posts have been developed that allow a rider to lower the seat post during an active ride, these previous designs have required the rider to sit on the saddle to drop the seat post. That is, the weight of the rider is needed to lower the seat post and thus the saddle. However, during a descent, riders would prefer not have to sit on the saddle to lower the seat post.

### SUMMARY

One illustrative embodiment is related to an apparatus including a first gas chamber, a second gas chamber, and a coupler. The first gas chamber can include a sleeve including a first mounting point and a cylinder including a second mounting point. In a first mode, the coupler can isolate the first gas chamber and the second gas chamber during a first translation range of the cylinder into the sleeve, and fluidly couple the first gas chamber to the second gas chamber during a second translation range of the cylinder into the sleeve. In a second mode, the coupler can fluidly couple the first gas chamber to the second gas chamber during at least the first translation range and the second translation range of the cylinder into the sleeve.

Another illustrative embodiment is related to an apparatus including a first gas chamber, a second gas chamber, a first valve and a second valve. A volume of the first gas chamber can be associated with a first mounting point of the first gas chamber and a second mounting point of the first gas chamber. The first valve can isolate the first gas chamber and the second gas chamber during a first translation range of the first mounting point and the second mounting point, and fluidly couple the first gas chamber to the second gas chamber during a second translation range of the first mounting point and the second mounting point. When the second valve is activated, the second valve can fluidly couple the first gas chamber to the second gas chamber during at least the first translation range and the second translation range of the first mounting point and the second mounting point.

Another illustrative embodiment is related to an apparatus including a first gas chamber, a second gas chamber, and a valve. The first gas chamber can include a sleeve including a first mounting point and a cylinder including a second mounting point. The second gas chamber can have a fixed volume. The valve can be configured with at least two valving sequences over a translation range of the cylinder into the sleeve. The valve can be configured to operate using one of the at least two valving sequences.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 is a diagram of a bicycle in accordance with an illustrative embodiment.

FIG. 2 is a side view of a shock in accordance with an illustrative embodiment.

FIG. 3 is a section side view of the shock of FIG. 2 in accordance with an illustrative embodiment.

FIG. 4 is a section view of the mount body of FIG. 2 in accordance with an illustrative embodiment.

FIG. 5 is a side view of the shock in accordance with an illustrative embodiment.

FIG. 6 is a section side view of the shock of FIG. 5 in accordance with an illustrative embodiment.

FIG. 7 is a section view of a mount body of FIG. 5 in accordance with an illustrative embodiment.

FIG. 8 is a side view of the shock in accordance with an illustrative embodiment.

FIG. 9 is a section side view of the shock of FIG. 8 in accordance with an illustrative embodiment.

FIG. 10 is a section view of a mount body of FIG. 8 in accordance with an illustrative embodiment.

FIG. 11 is a side view of the shock in accordance with an illustrative embodiment.

FIG. 12 is a section side view of the shock of FIG. 11 in accordance with an illustrative embodiment.

FIG. 13 is a section view of a mount body of FIG. 11 in accordance with an illustrative embodiment.

FIG. 14 is a section view of an alternate mount body of the shock of FIG. 11 in accordance with an illustrative embodiment.

FIG. 15 is a diagram of a first multiple mode shock in accordance with an illustrative embodiment.

FIG. 16 is a diagram of a second multiple mode shock in accordance with an illustrative embodiment.

FIG. 17 is a diagram of a multiple mode shock system in accordance with an illustrative embodiment.

FIG. 18 is a section view of a seat post in accordance with an illustrative embodiment.

FIG. 19 is a side view of a bicycle fork in accordance with an illustrative embodiment.

FIG. 20 is a front view of the bicycle fork of FIG. 19 in accordance with an illustrative embodiment.

FIG. 21 is a section view of the shock assembly of FIG. 19 in accordance with an illustrative embodiment.

FIG. 22 is a section view of a shock assembly in accordance with an illustrative embodiment.

FIG. 23 is a graph of a multiple mode shock response in accordance with an illustrative embodiment.

### DETAILED DESCRIPTION OF THE ILLUSTRATIVE EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

The present disclosure is directed to a multiple mode shock. The multiple mode shock can be an air spring. In one embodiment, the mode can be controlled electrically. In another embodiment, the mode can be controlled mechanically. Multiple modes are possible by changing the available air spring volume during translation ranges of the multiple mode shock.

In one embodiment, the multiple mode shock can include a first gas chamber, which can be a main gas spring, and a second gas chamber. The first gas chamber and the second gas chamber can be coupled by a coupler, such as a valve or valves. The valve or valves can be controlled, electrically or mechanically, to change how the first gas chamber and the second gas chamber work together. For example, in a first mode, the first gas chamber and the second gas chamber can always be fluidly coupled. In a second mode, the first gas chamber and the second gas chamber can be isolated during a first translation range of the shock and fluidly coupled during a second translation range of the shock. Other modes can be created by varying how and when the valve or valves open and close.

Referring to FIG. 15, a diagram of a first multiple mode shock 1500 in accordance with an illustrative embodiment is shown. The first multiple mode shock 1500 can include a shock body 1510, a first mounting point 1515, a piston 1520, and a second mounting point 1525. The piston 1520 can translate inside of the shock body 1510, forming a first gas chamber 1530. The first mounting point 1515 can be associated with or integrated into the shock body 1510. The second mounting point 1515 can be associated with or integrated into the piston 1520. The shock body 1510 can also include a second gas chamber 1540. The first mounting point 1515 can be located between the first gas chamber 1530 and the second gas chamber 1540. Alternatively, the second gas chamber 1540 can be remote from the shock body 1510. The first multiple mode shock 1500 can be a rear shock, a fork shock or any other shock.

The first multiple mode shock 1500 can also include a control valve 1550 fluidly coupled between the first gas chamber 1530 and the second gas chamber 1540. The control valve 1550 can be, for example, a Schrader valve, a plunger and piston combination, a solenoid valve, a bypass or any other kind of valve or coupling mechanism. The control valve 1550 can be configured to isolate the first gas chamber 1530 and the second gas chamber 1540 during a first translation range 1522 of the piston 1520 into the shock body 1510 and can be configured to fluidly couple the first gas chamber 1530 and the second gas chamber 1540 during a second translation range 1527 of the piston 1520 into the shock body 1510. For example, the first translation range 1522 can be the first half of the translation of the piston 1520 into the shock body 1510 and the second translation range 1527 can be the second half of the translation of the piston 1520 into the shock body 1510. The control valve 1550 can be activated, i.e., opened, partially opened, or closed, using electrical or mechanical means. The control valve 1550 can be a single valve or multiple valves. In another embodiment, a plurality of translation ranges can be configured such that each of the plurality of translation ranges can be associated with a particular state of the control valve 1550.

The first multiple mode shock 1500 can also include a fill valve 1570 and a second valve 1560. The fill valve 1570 can be fluidly coupled to the first gas chamber 1530 and an inlet of the second valve 1560. An outlet of the second valve 1560 can be fluidly coupled to the second gas chamber 1540. In one embodiment, the fill valve 1570 can and the second valve 1560 can be Schrader valves. In one embodiment, the fill valve 1570 can and the second valve 1560 can be configured such that the fill valve 1570 will open and then eventually cause the second valve 1560 to open as indicated by arrow 1590. For example, when the fill valve 1570 and the second valve 1560 are Schrader valves, a pin of the fill valve 1570 can be configured to press on a pin of the second valve 1560. In another embodiment, the fill valve 1570 can and the second valve 1560 can open and close simultaneously.

During setup, the first gas chamber 1530 and the second gas chamber 1540 can be pressurized using the fill valve 1570 and the second valve 1560. For example, a user can connect a shock pump to fill valve 1570. A head of the shock pump can open the fill valve 1570 and the second valve 1560. The user can then proceed to pressurize the first gas chamber 1530 and the second gas chamber 1540. For example, the first gas chamber 1530 and the second gas chamber 1540 can each be pressurized to 150 psi. The user can remove the shock pump thereby closing the fill valve 1570 and the second valve 1560, leaving the first gas chamber 1530 and the second gas chamber 1540 pressurized.

The first multiple mode shock 1500 can also include a cap 1580 configured to attached to the fill valve 1570. In one embodiment, the cap 1580 can be attached after pressurizing the first gas chamber 1530 and the second gas chamber 1540. In one embodiment, the cap 1580 can seal to fill valve 1570 to prevent depressurization of the first multiple mode shock 1500. The cap 1580 can include a valve activation mechanism configured to open and close the fill valve 1570 and the second valve 1560. For example, the valve activation mechanism can be a lever or button for depressing (opening) the fill valve 1570 which then depresses (opens) the second valve 1560. In an on state, the cap 1580 opens the fill valve 1570 and the second valve 1560. When the cap 1580 is in the on state, the first gas chamber 1530 and the second gas chamber 1540 are fluidly connected, but the first gas chamber 1530 and the second gas chamber 1540 do not depressurize. In an off state, the cap 1580 closes the fill valve 1570 and the second valve 1560. When the cap 1580 is in the off state, the first gas chamber 1530 and the second gas chamber 1540 are isolated by the second valve 1560; however, the first gas chamber 1530 and the second gas chamber 1540 can still be fluidly connected by the control valve 1550.

During a first mode (a dual rate control valve mode), the cap 1580 can be in the off state. In the first mode, the fill valve 1570 and the second valve 1560 can be closed. The control valve 1550 can isolate the first gas chamber 1530 and the second gas chamber 1540 during the first translation range 1522 of the piston 1520 into the shock body 1510. The control valve 1550 can fluidly couple the first gas chamber 1530 and the second gas chamber 1540 during a second translation range 1527 of the piston 1520 into the shock body 1510. For example, the first gas chamber 1530 and the second gas chamber 1540 can be isolated during the first half of the translation of the piston 1520 into the shock body 1510 and the first gas chamber 1530 and the second gas chamber 1540 can be fluidly coupled during the second half of the translation of the piston 1520 into the shock body 1510. In the first mode, during the first translation range 1522, the first gas chamber 1530 springs the first multiple mode shock 1500; but, during the second translation range 1527, the first gas chamber 1530 and the second gas chamber 1540 spring the first multiple mode shock 1500. Advantageously, in the first mode, during small compressions of the first multiple mode shock 1500, the first gas chamber 1530 can work alone resulting in a crisp spring response; but, during deep compressions, the first gas chamber 1530 and the second gas chamber 1540 can work together resulting in a plush spring response during deep hits.

During a second mode (an active climb mode), the cap 1580 can be in the on state. In the second mode, the fill valve 1570 and the second valve 1560 can be open. The control valve 1550 can still isolate the first gas chamber 1530 and the second gas chamber 1540 during the first translation range 1522 of the piston 1520 into the shock body 1510 and can still fluidly couple the first gas chamber 1530 and the second gas chamber 1540 during a second translation range 1527 of the piston 1520 into the shock body 1510. However, the open second valve 1560 bypasses the control valve 1550 such that the first gas chamber 1530 and the second gas chamber 1540 are fluidly coupled during both the first translation range 1522 and the second translation range 1527. Thus, in second mode, the first gas chamber 1530 and the second gas chamber 1540 spring the first multiple mode shock 1500. Advantageously, in the second mode, during a climb, a sag of the first multiple mode shock 1500 is reduced resulting in a stiffer, thus, easier climb for the rider.

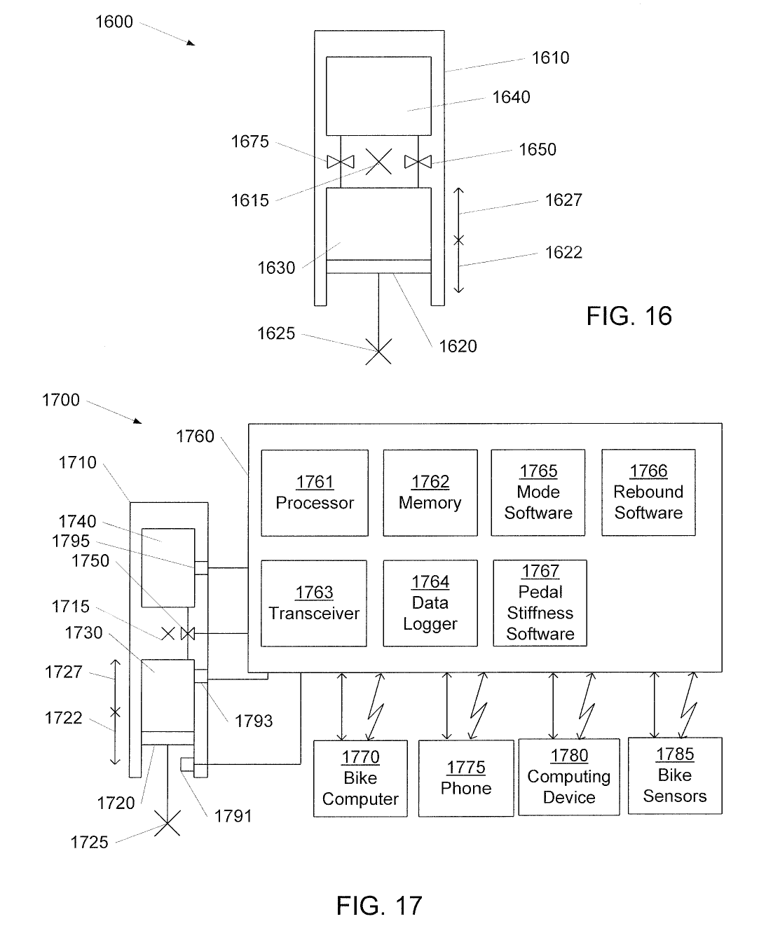

Referring to FIG. 16, a diagram of a second multiple mode shock 1600 in accordance with an illustrative embodiment is shown. The second multiple mode shock 1600 can include a shock body 1610, a first mounting point 1615, a piston 1620, and a second mounting point 1625. The piston 1620 can translate inside of the shock body 1610, forming a first gas chamber 1630. The first mounting point 1615 can be associated with or integrated into the shock body 1610. The second mounting point 1625 can be associated with or integrated into the piston 1620. The shock body 1610 can also include a second gas chamber 1640. The first mounting point 1515 can be located on one side of the first gas chamber 1530 and the second gas chamber 1540. Alternatively, the second gas chamber 1640 can be remote from the shock body 1610. Alternatively, the second gas chamber 1640 can be fluidly coupled to an auxiliary gas chamber 1645, in order to increase the volume of the second gas chamber 1640. The second multiple mode shock 1600 can be a rear shock, a fork shock or any other shock.

The second multiple mode shock 1600 can also include a control valve 1650 fluidly coupled between the first gas chamber 1630 and the second gas chamber 1640. The control valve 1650 can be, for example, a Schrader valve, a plunger and piston combination, a solenoid valve, a bypass or any other kind of valve or coupling mechanism. The control valve 1650 can be configured to isolate the first gas chamber 1630 and the second gas chamber 1640 during a first translation range 1622 of the piston 1620 into the shock body 1610 and can be configured to fluidly couple the first gas chamber 1630 and the second gas chamber 1640 during a second translation range 1627 of the piston 1620 into the shock body 1610. For example, the first translation range 1622 can be the first half of the translation of the piston 1620 into the shock body 1610 and the second translation range 1627 can be the second half of the translation of the piston 1620 into the shock body 1610. The control valve 1650 can be activated, i.e., opened, partially opened, or closed, using electrical or mechanical means. The control valve 1650 can be a single valve or multiple valves. In another embodiment, a plurality of translation ranges can be configured such that each of the plurality of translation ranges can be associated with a particular state of the control valve 1650.

The second multiple mode shock 1600 can also include a mode valve 1675 fluidly coupled between the first gas chamber 1630 and the second gas chamber 1640. The mode valve 1675 can be for example, a Schrader valve, a plunger and piston combination, a solenoid valve, a bypass or any other kind of valve or coupling mechanism. The mode valve 1675 can include a valve activation mechanism configured to open and close the mode valve 1675. For example, the valve activation mechanism can be a lever or button for rotating or depressing (opening) the mode valve 1675. Alternatively, the valve activation mechanism can include a solenoid, motor, or remote cable for manipulating the lever or button. In an on state, the mode valve 1675 can be open or partially open. When the mode valve 1675 is in the on state, the first gas chamber 1630 and the second gas chamber 1640 are fluidly connected. In an off state, the mode valve 1675 can be closed. When the mode valve 1675 is in the off state, the first gas chamber 1630 and the second gas chamber 1640 can be isolated; however, the first gas chamber 1630 and the second gas chamber 1640 can still be fluidly connected by the control valve 1650.

During setup, the first gas chamber 1630 and the second gas chamber 1640 can be pressurized using a fill valve (not shown). During a first mode (a dual rate control valve mode), the mode valve 1675 can be in the off state. In the first mode, the mode valve 1675 can be closed. The control valve 1650 can isolate the first gas chamber 1630 and the second gas chamber 1640 during the first translation range 1622 of the piston 1620 into the shock body 1610. The control valve 1650 can fluidly couple the first gas chamber 1630 and the second gas chamber 1640 during a second translation range 1627 of the piston 1620 into the shock body 1610. For example, the first gas chamber 1630 and the second gas chamber 1640 can be isolated during the first half of the translation of the piston 1620 into the shock body 1610 and the first gas chamber 1630 and the second gas chamber 1640 can be fluidly coupled during the second half of the translation of the piston 1620 into the shock body 1610. In the first mode, during the first translation range 1622, the first gas chamber 1630 springs the second multiple mode shock 1600; but, during the second translation range 1627, the first gas chamber 1630 and the second gas chamber 1640 spring the second multiple mode shock 1600. Advantageously, in the first mode, during small compressions of the second multiple mode shock 1600, the first gas chamber 1630 can work alone resulting in a crisp spring response; but, during deep compressions, the first gas chamber 1630 and the second gas chamber 1640 can work together resulting in a plush spring response during deep hits.

During a second mode (an active climb mode), the mode valve 1675 can be in the on state. In the second mode, the mode valve 1675 can be open. The control valve 1650 can still isolate the first gas chamber 1630 and the second gas chamber 1640 during the first translation range 1622 of the piston 1620 into the shock body 1610 and can still fluidly couple the first gas chamber 1630 and the second gas chamber 1640 during a second translation range 1627 of the piston 1620 into the shock body 1610. However, the open mode valve 1675 bypasses the control valve 1650 such that the first gas chamber 1630 and the second gas chamber 1640 are fluidly coupled during both the first translation range 1622 and the second translation range 1627. Thus, in second mode, the first gas chamber 1630 and the second gas chamber 1640 spring the second multiple mode shock 1600. Advantageously, in the second mode, during a climb, a sag of the second multiple mode shock 1600 is reduced resulting in a stiffer, thus, easier climb for the rider.

Referring to FIG. 17, a diagram of a multiple mode shock system 1700 in accordance with an illustrative embodiment is shown. The multiple mode shock system 1700 can include a shock body 1710, a first mounting point 1715, a piston 1720, and a second mounting point 1725. The piston 1720 can translate inside of the shock body 1710, forming a first volume 190. The first mounting point 1715 can be associated with or integrated into the shock body 1710. The second mounting point 1725 can be associated with or integrated into the piston 1720. The shock body 1710 can also include a second volume 200. The first mounting point 1515 can be located on the shock body 1710. The multiple mode shock system 1700 can be configured for a rear shock, a fork shock or any other shock.

The multiple mode shock system 1700 can also include a solenoid 3020 fluidly coupled between the first volume 190 and the second volume 200. In one embodiment, the solenoid 3020 can be a solenoid valve. In other embodiments, the solenoid 3020 can be for example, a Schrader valve, a plunger and piston combination, a motorized valve, a bypass or any other kind of valve or coupling mechanism. The solenoid 3020 can be activated, i.e., opened, partially opened, or closed, using electrical or mechanical means. The solenoid 3020 can be a single valve or multiple valves. In another embodiment, a plurality of translation ranges can be configured such that each of the plurality of translation ranges can be associated with a particular state of the solenoid 3020.

During a first mode (a dual rate control valve mode), the solenoid 3020 can be configured to isolate the first volume 190 and the second volume 200 during a first translation range 1722 of the piston 1720 into the shock body 1710 and can be configured to fluidly couple the first volume 190 and the second volume 200 during a second translation range 1727 of the piston 1720 into the shock body 1710. For example, the first translation range 1722 can be the first half of the translation of the piston 1720 into the shock body 1710 and the second translation range 1727 can be the second half of the translation of the piston 1720 into the shock body 1710. Hence, the first volume 190 and the second volume 200 can be isolated during the first half of the translation of the piston 1720 into the shock body 1710 and the first volume 190 and the second volume 200 can be fluidly coupled during the second half of the translation of the piston 1720 into the shock body 1710. In the first mode, during the first translation range 1722, the first volume 190 springs the multiple mode shock system 1700; but, during the second translation range 1727, the first volume 190 and the second volume 200 spring the multiple mode shock system 1700. Advantageously, in the first mode, during small compressions of the multiple mode shock system 1700, the first volume 190 can work alone resulting in a crisp spring response; but, during deep compressions, the first volume 190 and the second volume 200 can work together resulting in a plush spring response during deep hits.

During a second mode (an active climb mode), the solenoid 3020 can be configured to be always open or partially open. Thus, the first volume 190 and the second volume 200 are fluidly coupled by the solenoid 3020 during both the first translation range 1722 and the second translation range 1727. Thus, in second mode, the first volume 190 and the second volume 200 spring the multiple mode shock system 1700. Advantageously, in the second mode, during a climb, a sag of the multiple mode shock system 1700 is reduced resulting in a stiffer, thus, easier climb for the rider.

In another embodiment, during a third mode, the solenoid 3020 can be configured to be always closed. Thus, the first volume 190 and the second volume 200 are isolated by the solenoid 3020 during both the first translation range 1722 and the second translation range 1727. Thus, in third mode, the first volume 190 springs the multiple mode shock system 1700.

The solenoid 3020 can be controlled by a controller 1760. The controller 1760 can include one or more of, a processor 1761, a memory 1762, data logging software 1764, mode software 1765, rebound software 1766, pedal stiffness software 1766, a display, a user interface, and a transceiver 1763. In alternative embodiments, the controller 1760 may include fewer, additional, and/or different components. The memory 1762, which can be any type of permanent or removable computer memory known to those of skill in the art, can be a computer-readable storage medium. The memory 1762 can be configured to store one or more of the data logging software 1764, mode software 1765, rebound software 1766, pedal stiffness software 1766, an application configured to run the software 1764, 1765, 1766, and 1767, capture data, and/or other information and applications as known to those of skill in the art. The transceiver 1763 can be used to receive and/or transmit information through a wired or wireless network as known to those of skill in the art. The transceiver 1763, which can include a receiver and/or a transmitter, can be a modem or other communication component known to those of skill in the art. In another embodiment, the controller 1760 can also control additional valves of the multiple mode shock system 1700. The controller 1760 can be powered by a battery, a solar panel, a dynamo, a generator, another computing device, or any other power source.

The controller 1760 can be communicatively connected, wired or wirelessly, to a position sensor 1791, a first pressure sensor 1793, a second pressure sensor 1795, or any other sensor. The position sensor 1791 can be configured to sense the translation of the piston 1720 into the shock body 1710. The position sensor 1791 can be, for example, a Hall effect sensor, a capacitive sensor, an inductive sensor, a proximity sensor, an encoder, a resolver, a resistive position sensor, an opto-electronic sensor, or any other type of sensor. The position sensor 1791 can be located, for example, on the shock body 1710 in a position to track the piston 1720. The first pressure sensor 1793 and the second pressure sensor 1795 can be, for example, a MEMS-type pressure sensor, a differential pressure sensor, or any other pressure sensor. The first pressure sensor 1793 can be located in the first volume 190. The second pressure sensor 1795 can be located in the second volume 200.

The controller 1760 can also be communicatively connected, wired or wirelessly, to a bike computer 1770, a phone 1775, a computing device 1780, and other bike sensors 1785. The bike computer 1770 can be, for example, a small interface for displaying and tracking the performance of a bike and a rider. In one embodiment, the controller 1760 can send and receive data to and from the bike computer 1770. For example, the rider can use the bike computer 1770 to instruct the controller 1760 to change from the first mode to the second mode. The phone 1775 can be, for example, a smart phone such as an iPhone™ available from Apple Computer Corp., Cupertino, Calif., or an Android™-type phone available various suppliers such Motorola Corp., Schaumberg, Ill. The phone 1775 can, for example, be attached to the handlebar of a bicycle. The phone 1775 can, for example, include software, such as an application, that provides an interface for the controller 1760 and the rider. In one embodiment, the controller 1760 can send and receive data to and from the phone 1775. For example, the rider can use the phone 1775 to instruct the controller 1760 to change from the first mode to the second mode. The computing device 1780 can be a personal computer, a laptop, or any other kind of computer. The computing device 1780 can, for example, include software, such as an application, that provides an interface for the controller 1760 and the rider. In one embodiment, the controller 1760 can send and receive data to and from the computing device 1780. For example, the rider can use the computing device 1780 to instruct the controller 1760 to send performance data of the multiple mode shock system 1700.

The bike sensors 1785 can be sensors located on the bike, for example, an accelerometer, a gyroscope, a global positioning system (GPS) sensor, or any other sensor. The controller 1760 can send and receive data to and from the bike sensors 1785. For example, the controller 1760 can collect multi-dimensional acceleration information from the bike sensors 1785.

The data logging software 1764 can be configured to collect and condition sensor and valving data. For example, data from the position sensor 1791 can be stored in memory 1762. Likewise, the data logging software 1764 can record the mode and state of solenoid 3020. The data can be communicated, for example, to social networking web sites so that a rider can share his or her ride experiences. The data can be logged and downloaded to a PC or it can be logged and viewed on a smart phone. The data can be analyzed on a PC or smart phone and so that a rider can adjust the sag and rebound accordingly for the next time the rider rides the trail.

The mode software 1765 can be configured to set the mode of the multiple mode shock system 1700. In one embodiment, the mode software 1765 can open and close the solenoid 3020 based on the mode and the position of the piston 1720 relative to the shock body 1710. For example, the mode software 1765 can receive mode information such as a command from the rider to place the multiple mode shock system 1700 into the first mode. The mode software 1765 can then control the solenoid 3020 in accordance with the first mode (dual rate control valve) as described above. Alternatively, the mode software 1765 can determine the optimal mode for the rider based on sensor information. For example, the mode software 1765 can receive accelerometer data and determine that the rider is pedaling uphill. The mode software 1765 can automatically set the multiple mode shock system 1700 in second mode (active climb) and open the solenoid 3020.

In another embodiment, the mode software 1765 can be configured to set multiple modes. For example, the mode software 1765 can include a third mode where the solenoid 3020 is closed during a third translation range. In another embodiment, the mode software 1765 can include a plurality of valving sequences. Each valving sequence can be associated with a mode. The valving sequence can include a series of valve activation that will occur during the translation of the shock. For example, during a first translation range a valve or valves could be open, during a second translation range the valve or the valves could be partially open, and during a third translation range the valve or the valves could be closed. In another example, the valve or valves could be controlled based on a pulse width modulation scheme. Any sequence of valve activations over the translation range is possible.

The rebound software 1766 can be configured to change a rebound setting of the multiple mode shock system 1700. For example, a shock can include a rebound adjustment that changes how quickly the shock recovers. The rebound software 1766 can control valving or an adjustment associated with the rebound.

The pedal stiffness software 1766 can be configured to change a stiffness setting of the multiple mode shock system 1700. For example, a shock can include a stiffness adjustment that changes how much bounce the shock has associated with pedaling. The pedal stiffness software 1766 can control valving or an adjustment associated with the stiffness.

In one embodiment, the data logging software 1764, mode software 1765, rebound software 1766, and pedal stiffness software 1766 can include a computer program such as C++ or Java and/or an application configured to execute the program. Alternatively, other programming languages and/or applications known to those of skill in the art can be used. In one embodiment, the data logging software 1764, mode software 1765, rebound software 1766, and pedal stiffness software 1766 can be a dedicated standalone application. The processor 1761, which can be in electrical communication with each of the components of the multiple mode shock system 1700, can be used to run the application and to execute the instructions of the data logging software 1764, mode software 1765, rebound software 1766, and pedal stiffness software 1766. Any type of computer processor(s) known to those of skill in the art may be used.

Alternatively, solenoid 3020 can be manipulated between the first mode and the second mode at least in part by a mechanism. For example, a lever can be used to prop the solenoid 3020 open in the second mode. Further, in the first mode, the lever can be moved out of the way of the solenoid 3020 so as to not infer with the operation of the solenoid 3020.

Advantageously, in the first mode, during small compressions of the multiple mode shock system 1700, the first volume 190 can work alone resulting in a crisp spring response; but, during deep compressions, the first volume 190 and the second volume 200 can work together resulting in a plush spring response during deep hits. Advantageously, in the second mode, during a climb, a sag of the multiple mode shock system 1700 is reduced resulting in a stiffer, thus, easier climb for the rider.

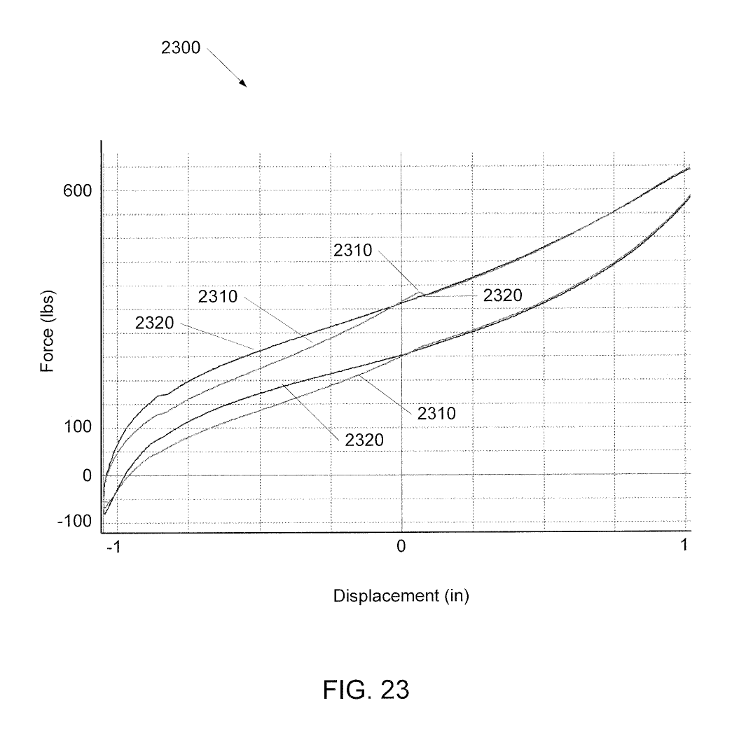

Referring to FIG. 23, a graph of a multiple mode shock response 2300 in accordance with an illustrative embodiment is shown. The graph of the multiple mode shock response 2300 shows force (lbs.) versus displacement (in) for a modified 56 mm FLOAT RP23 DRCV shock available from FOX Factory, Inc., Scotts Valley, Calif. The modified shock was pressurized at 170 psi. Plot 2310 shows the response for the modified shock in dual rate control valve (DRCV) mode (described as “first mode” above). Plot 2310 shows the response for the modified shock in active climb mode (described as “second mode” above). The sag for the modified shock in DRCV mode is approximately 30% or 0.675 in of sag. The sag for the modified shock in active climb mode is approximately 23% or 0.53 in of sag. Thus, switching from DRCV mode to active climb mode reduced the sag by 0.145 in, in other words, extended the length of the shock by 0.145 in. Advantageously, the active climb mode reduces sag and is useful for steep and/or technical climbing.

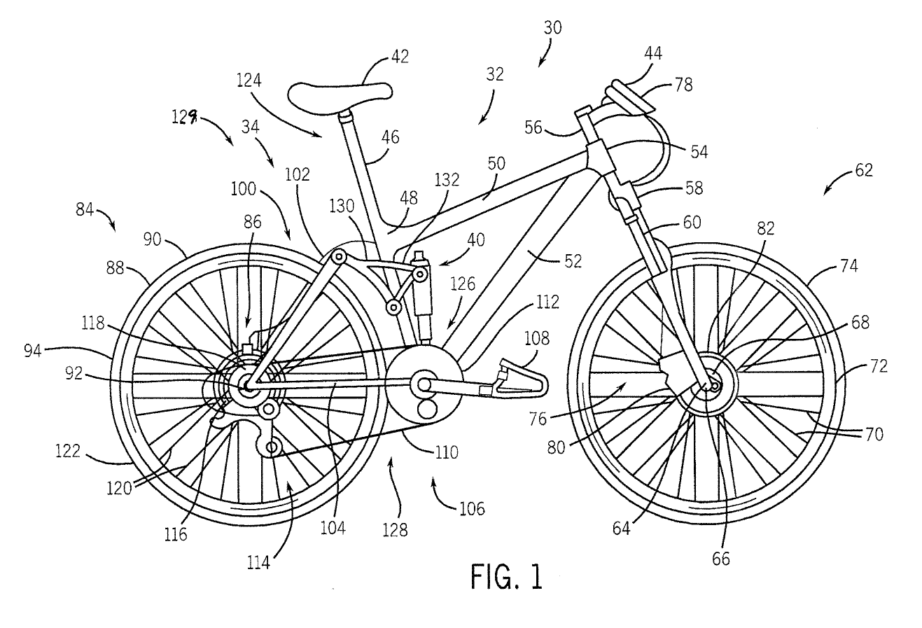

Referring to FIG. 1, a diagram of a bicycle 30 in accordance with an illustrative embodiment is shown. The bicycle 30 can include a frame assembly 32 equipped with a rear wheel suspension system 34 that can include a shock absorber, shock assembly, or shock 40. Bicycle 30 can include a seat 42 and handlebars 44 that are attached to frame assembly 32. A seat post 46 can be connected to seat 42 and slidably engage a seat tube 48 of frame assembly 32. A top tube 50 and a down tube 52 can extend forwardly from seat tube 48 to a head tube 54 of frame assembly 32. Handlebars 44 can be connected to a stem 56 that passes through head tube 54 and engage a fork crown 58. A pair of forks 60 can extend from generally opposite ends of fork crown 58 and support a front wheel assembly 62 at an end of each fork or a fork tip 64. Fork tips 64 can engage generally opposite sides of an axle 66 that cooperates with a hub 68 of front wheel assembly 62. A number of spokes 70 can extend from hub 68 to a rim 72 of front wheel assembly 62. A tire 74 can extend about rim 72 such that rotation of tire 74, relative to forks 60, rotates rim 72 and hub 68.

In one embodiment, each fork 60 can be a shock absorber so as to allow translation of axle 66 of front wheel assembly 62 relative to frame assembly 32. Although each fork 60 is shown as having respective ends secured proximate one of frame assembly 32 and axle 66, shocks according to one or more of the illustrative embodiments can be equally applicable to bicycle front wheel suspension features.

Bicycle 30 can include a front brake assembly 76 having an actuator 78 attached to handlebars 44. Brake assembly 76 can include a caliper 80 that cooperates with a rotor 82 to provide a stopping or slowing force to front wheel assembly 62. A rear wheel assembly 84 of bicycle 30 can also include a disc brake assembly 86 having a rotor 88 and a caliper 90 that are positioned proximate a rear axle 92. A rear wheel 94 can be positioned generally concentrically about rear axle 92. One or both of front wheel assembly 62 and rear wheel assembly 84 can be equipped with other brake assemblies, such as brakes assemblies that include structures that engage the rim or tire of a respective wheel assembly.

A rear wheel suspension system 100 can be pivotably connected to frame assembly 32 and allows rear wheel 94 to move independent of seat 42 and handlebars 44. Suspension system 100 can include a seat stay 102 and a chain stay 104 that offset rear axle 92 from a crankset 106. Crankset 106 can include oppositely positioned pedals 108 that can be operationally connected to a chain 110 via a chain ring or sprocket 112. Rotation of chain 110 can communicate a drive force to a rear section 114 of bicycle 30. A gear cluster 116 can be positioned at rear section 114 and engage chain 110. The gear cluster 116 can be generally concentrically orientated with respect to rear axle 92 and can include a number of variable diameter gears. The gear cluster 116 can be operationally connected to a hub 118 of rear wheel 94 of rear wheel assembly 84. A number of spokes 120 can extend radially between hub 118 and a rim 122 of rear wheel assembly 84. Rider operation of pedals 108 can drive chain 110 thereby driving rear wheel 94 which in turn propels bicycle 30.

Frame assembly 32 can include a first frame member or forward frame portion 124 that generally can include seat tube 48, top tube 50, down tube 52, and head tube 54. A bottom bracket 126 can be formed proximate the interface of seat tube 48 and down tube 52 and can be constructed to operatively connect crankset 106 to bicycle frame assembly 32. A first end 128 of chain stay 104 can be pivotably connected to forward frame portion 124 proximate bottom bracket 126 to allow a second frame member or rear frame portion 129 to pivot or rotate relative to forward frame portion 124. The rear frame portion 129 generally can include chain stays 104, seat stays 102, and a pivot or rocker arm 130 that is attached to forward frame portion 124. The rocker arm 130 can be pivotably attached to seat tube 48 of forward frame portion 124.

The rocker arm 130 can include a forward arm 132 that extends inboard relative to seat tube 48. The shock 40 can be secured between forward arm 132 of rocker arm 130 and a position proximate bottom bracket 126. The shock 40 can be attached directly to forward frame portion 124. The chain stay 104 can be pivotably attached to seat tube 48 and extend forward of seat tube 48 proximate the bottom bracket 126. Such a construction can indirectly secure the shock 40 to the forward frame portion 124 and can allow both mounting points of the shock 40 to move or pivot during operation of suspension system 100. This orientation of suspension system 100 is more fully described in U.S. patent application Ser. No. 11/735,816, filed on Apr. 16, 2007, the disclosure of which is incorporated herein in its entirety.

The shock 40 can arrest, suppress, or dampen motion between the rear frame portion 129 and the forward frame portion 124. The frame assembly 32 is illustrative of one frame assembly usable with the present subject matter. Other frame assemblies, such as frame assemblies having other moveable frame structures or other shock orientations can be used. The shock 40 can be positioned in any number of positions relative to the forward frame portion 124. For instance, when located in a forward position, the shock 40 can provide a forward wheel suspension feature where one end of the shock is secured proximate a forward wheel axle and another end of the shock is secured nearer the frame assembly 32. In a rearward position, the shock 40 could be positioned rearward of seat tube 48, such as between a seat stay and seat tube 48. In other embodiments, rather than the generally vertical orientation shown in FIG. 1, the shock 40 can be generally aligned with top tube 50 and engaged with a U-shaped seat stay that can be movable relative to seat tube 48.

Multi-Mode Shock

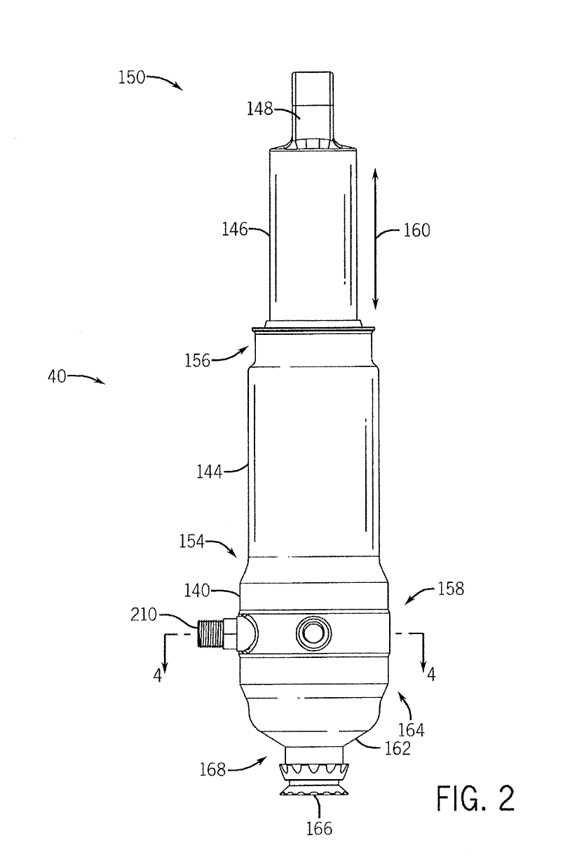

Referring to FIG. 2, a side view of a shock 40 in accordance with an illustrative embodiment is shown. The shock 40 can include a mount or mount body 140 disposed between a first cap 142 and a second cap or sleeve 144. The shock 40 can include a cylinder 146 that can be translatable relative to sleeve 144. An eyelet 148 can be formed at a first end 150 of shock 40 and provide a first point for mounting of shock 40 to bicycle 30. The sleeve 144 can extend between a first end 154 and a second end 156. The first end 154 of sleeve 144 can cooperate with a first end 158 of mount body 140, and the second end 156 of sleeve 144 can slidably receive the cylinder 146. The cylinder 146 can be translatable, indicated by arrow 160, within sleeve 144 relative to mount body 140. The distance of translation of cylinder 146 can be defined roughly by the overlapping lengths of sleeve 144 and cylinder 146.

The shock 40 can include a second cap 162 that can be attached to an end 164 of mount body 140 opposite sleeve 144. The cap 162, as with all of the outboard caps of the multiple embodiments disclosed herein, can be constructed to removably cooperate with mount body 140. The cap 162 shown in FIG. 2 is merely illustrative of one size and shape of cap usable with the present invention. That is, mount body 140 can be constructed to cooperate with any of a number of differently sized caps. As described further below, such a construction can allow the shock 40 to be configured to individual user preferences without otherwise interfering with the interaction of connection of the shock 40 with a bicycle. An operator, such as a dial 166, can be positioned near a second end 168 of the shock 40 and can be adjusted to alter the suspension performance of shock 40.

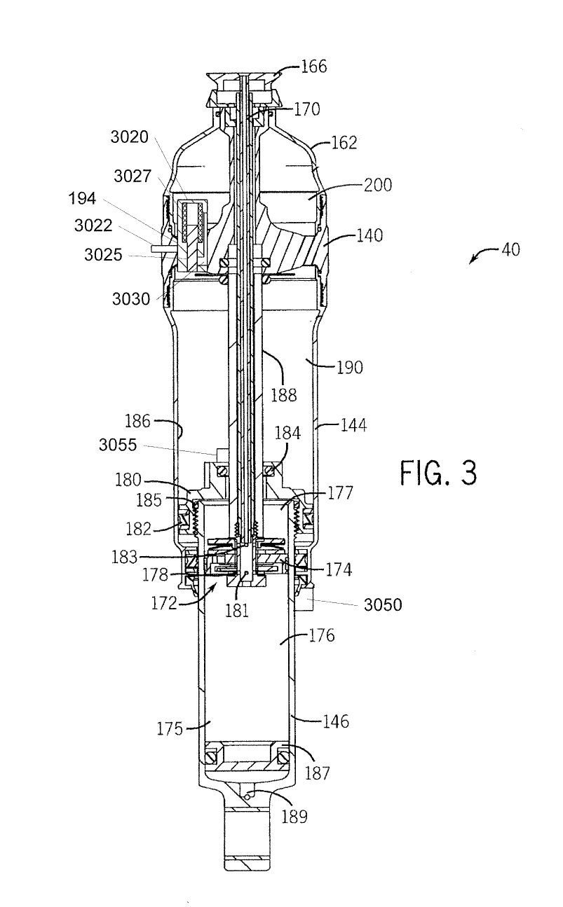

Referring to FIG. 3, a section side view of the shock 40 of FIG. 2 in accordance with an illustrative embodiment is shown. A stem 170 can extend from dial 166 into the mount body 140. The stem 170 can be operatively connected to a valve assembly 172 positioned in cylinder 146. The valve assembly 172 can include a piston 174 that can be positioned in a cavity 176 of cylinder 146. Piston 174 can divide cavity 176 into a first chamber 175 and a second chamber 177. The position of piston 174 can be fixed relative to sleeve 144 but can be constructed to accommodate the translation of cylinder 146 relative to sleeve 144.

A passage 178 can fluidly connect chambers 175, 177 on opposite sides of piston 174. In one embodiment, passage 178 can include upper and lower orifices 181, 183, respectively, that can dictate the performance of a flow of fluid, such as oil, between chambers 175, 177. The cylinder 146 can include a cap 180 that can have a first seal 182, a second seal 184, and a third seal 185. The first seal 182 can slidably cooperate with an interior surface 186 of the sleeve 144. The second seal 184 can slidably cooperate with an exterior surface 188 of the stem 170. The third seal 185 can cooperate with cylinder 146 so as to maintain the volume of fluid in cylinder 146. A float 187 and a vent 189 can cooperate with cylinder 146 so as to equalize the pressure on opposite sides of the piston 174 during translation of the cylinder 146 relative to the sleeve 144. Manipulation of the dial 166 can alter the exposure or size of orifices 181, 183 and thereby alter the damping performance of the shock 40.

A first volume 190 can be formed by the sleeve 144, the mount body 140, and the cap 180. The first volume 190 can be a gas chamber configured to contain a pressurized gas such as air or nitrogen. A second volume 200 can be formed by the mount body 140 and the cap 162. The second volume 200 can be a gas chamber configured to contain a pressurized gas such as air or nitrogen. The cap 162 can removably cooperate with mount body 140 and dial 166 such that caps having other sizes and/or shapes can be connected to mount body 140. Altering the size and/or shape of cap 162 alters the volume of the second volume 200. Altering air chamber 200 can alter the air spring performance of shock 40.

A passage 194 can be formed through mount body 140. A solenoid 3020 can be fitted into the passage 194. The solenoid 3020 can include a coil 3027, a solenoid plunger 3025, a solenoid passage 3030, and solenoid control contacts 3022. The solenoid passage 3030 can selectively fluidly connect the first volume 190 and the second volume 200 using the solenoid plunger 3025 as a valve.

During a first mode (a dual rate control valve mode), the solenoid 3020 can be configured to isolate the first volume 190 and the second volume 200 during a first translation range of the cylinder 146 into the sleeve 144 and can be configured to fluidly couple the first volume 190 and the second volume 200 during a second translation range of the cylinder 146 into the sleeve 144. For example, the first translation range can be the first half of the translation of the cylinder 146 into the sleeve 144 and the second translation range can be the second half of the translation of the cylinder 146 into the sleeve 144. During the first translation range, the solenoid plunger 3025 can block the solenoid passage 3030, isolating the first volume 190 and the second volume 200. During the second translation range, the solenoid plunger 3025 opens the solenoid passage 3030, fluidly connecting the first volume 190 and the second volume 200. Hence, the first volume 190 and the second volume 200 can be isolated during the first half of the translation of the cylinder 146 into the sleeve 144 and the first volume 190 and the second volume 200 can be fluidly coupled during the second half of the translation of the cylinder 146 into the sleeve 144. In the first mode, during the first translation range 1722, the first volume 190 springs the multiple mode shock system 1700; but, during the second translation range 1727, the first volume 190 and the second volume 200 spring the shock 40. Advantageously, in the first mode, during small compressions of the multiple mode shock system 1700, the first volume 190 can work alone resulting in a crisp spring response; but, during deep compressions, the first volume 190 and the second volume 200 can work together resulting in a plush spring response during deep hits.

During a second mode (an active climb mode), the solenoid 3020 can be configured to be always open or partially open. Thus, the first volume 190 and the second volume 200 are fluidly coupled by the solenoid 3020 during both the first translation range and the second translation range 1727. Thus, in second mode, the first volume 190 and the second volume 200 spring the shock 40. Advantageously, in the second mode, during a climb, a sag of the shock 40 is reduced resulting in a stiffer, thus, easier climb for the rider.

In another embodiment, during a third mode, the solenoid 3020 can be configured to be always closed. Thus, the first volume 190 and the second volume 200 are isolated by the solenoid 3020 during both the first translation range and the second translation range 1727. Thus, in third mode, the first volume 190 springs the shock 40.

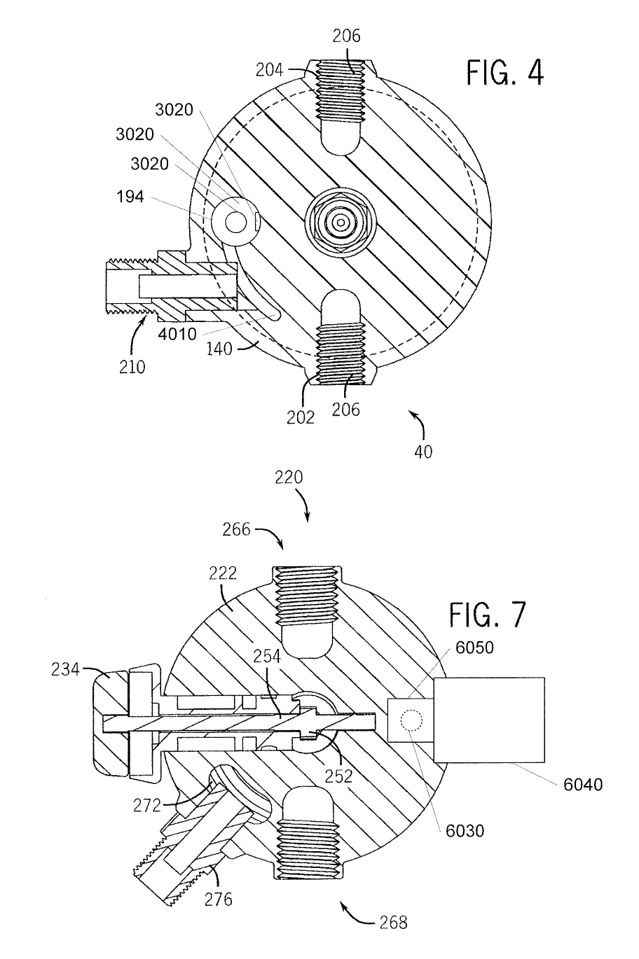

Referring to FIG. 4, a section view of the mount body 140 of FIG. 2 in accordance with an illustrative embodiment is shown. The mount body 140 can includes a first opening 202 and a second opening 204 that are located generally opposite one another. In one embodiment, openings 202, 204 can include a number of threads 206 that cooperate with a fastener (not shown) for securing shock 40 to bicycle 30. In one embodiment, openings 202, 204 can be a first mounting point. Openings 202, 204 can be fluidly isolated from one another and fluidly isolated from any of the gas or fluid chambers, such as passage 194 of shock 40. Alternatively, openings 202, 204 could be constructed as a through opening or bore so as to receive the shank of a fastener or the like. The openings 202, 204 can be fluidly connected to second volume 200 provided mounting fasteners can be sealing engaged therewith.

The mount body 140 can include a valve assembly 210. The valve assembly 210 can allow pressurization of the second volume 200 of shock 40 via groove 4010. The solenoid 3020 can be opened during fill to allow pressurization of the first volume 190 via passage 3030. In one embodiment, the valve assembly 210 can be a Schrader valve. The valve assembly 210 can cooperate with shock 40 such that the amount of gas associated with second volume 200 can be adjusted. The second volume 200 can be charged with any of air, nitrogen, carbon dioxide, or any other gas. For most riders, second volume 200 can be charge to a pressure in the range of about 100 to about 300 psi; however, second volume 200 can be charges to any pressure. Lighter riders may prefer a less rigid suspension performance and may desire gas pressures nearer about 25 psi whereas larger riders may prefer a more robust spring response and prefer pressures nearer about 300 psi. The size and pressure of second volume 200 can be configured to individual rider preference. Such a construction further enhances the ability to individualize the suspension performance operation of the shock 40. The shock 40 can include a number of features for providing an individual rider's desired suspension performance by simply altering the fluid performance of cylinder 146 via manipulation of dial 166 (i.e., changing the damping) or through changing cap 162 to alter the performance of the second volume 200, or via altering the pressure associated with the second volume 200. Each of these shock performance features can be utilized without otherwise altering the mounting of shock 40 to a bicycle or removing the shock 40 from a bicycle.

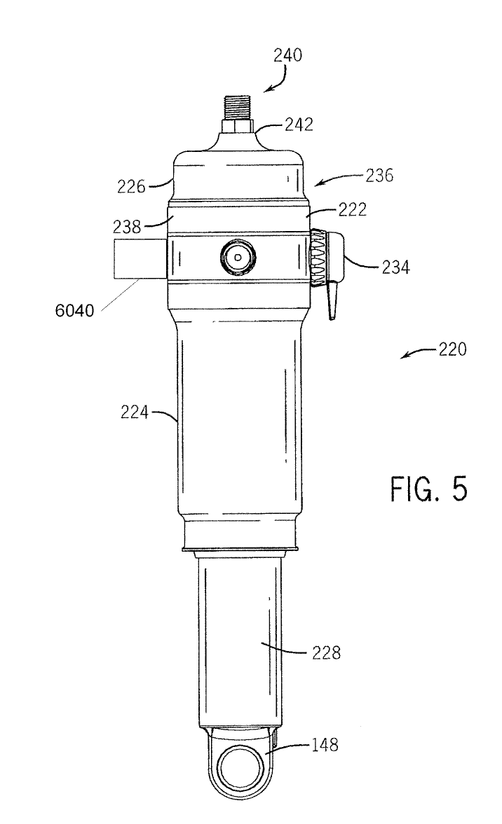

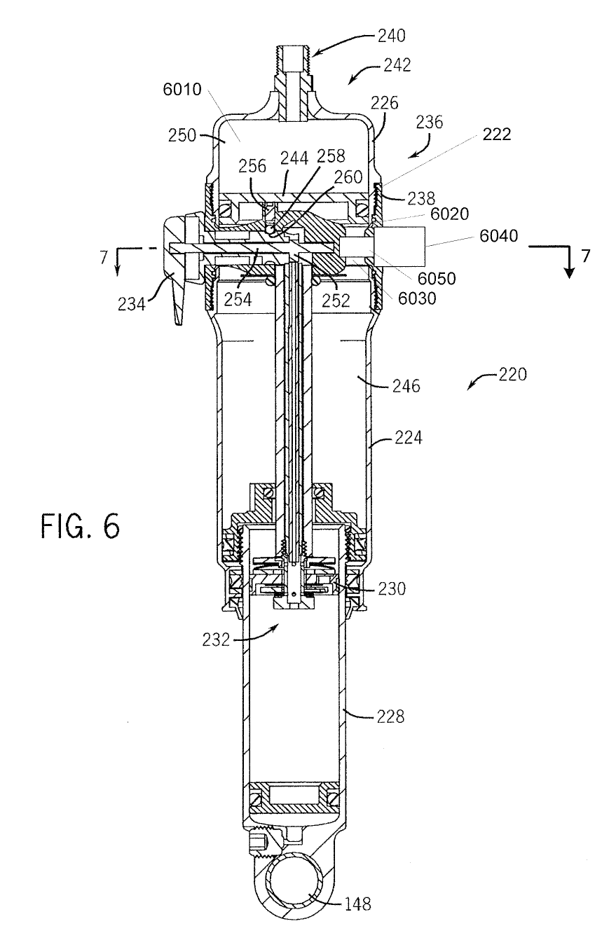

FIGS. 5-7 show a shock assembly or shock 220 in accordance with another illustrative embodiment. Referring to FIG. 5, a side view of the shock 220 in accordance with an illustrative embodiment is shown. Referring to FIG. 6, a section side view of the shock 220 of FIG. 5 in accordance with an illustrative embodiment is shown. Referring to FIG. 7, a section view of a mount body 222 of FIG. 5 in accordance with an illustrative embodiment is shown.

The shock 220 can include the mount body 222 positioned between a sleeve 224 and a removable or replaceable second cap 226. A cylinder 228 can be slidably positioned relative to the sleeve 224. A piston 230 and valve assembly 232 can be constructed and operate in a similar manner as that described above with respect to shock 40 of FIGS. 2-4. Accordingly, like reference numbers have been used to describe features common to various embodiments.

Unlike shock 40, where the dial 166 can extend from a longitudinal end of the shock 40, shock 220 can include an operator or dial 234 that can extend from a lateral side of the mount body 222. A first end 236 of replaceable cap 226 can be threadably engaged with an end 238 of the mount body 222. A valve assembly 240 is operatively associated with another end 242 of replaceable cap 226. Valve assembly 240 is generally similar to or the same as valve assembly 210. A piston 244 can be slidably disposed within cap 226 and separates an air chamber 250 of shock 220 into a first air volume 6010 and a second air volume 6020. Such a construction allows first air volume 6010 to be charged with gas, such as nitrogen, carbon dioxide or air to a first pressure that is generally greater than a gas pressure associated with the second air volume 6020. As described below, such a configuration allows a user to flatten the spring performance of shock 220 by withholding the contribution of the first air volume 6010 from the performance of shock 220 until the first air volume 6010 attains a pressure sufficient to displace piston 244. A third air volume 246 can be defined by the sleeve 224, the mount body 222, and the cylinder 228. The third air volume 246 can be pressurized using fill valve 294 via passage 272.

The dial 234 can be connected to a cam 252 that can manipulate the performance of valve assembly 232. A stem 254 can extend between the cam 252 and the dial 234 and can cooperate with an indicator 256, such as a ball 258 and detent 260. The indicator 256 can provide a user with an audible or tactile indication of the adjustment of the dial 234.

The mount body 222 of shock 220 can include first and second recesses 266, 268 that facilitate mounting shock 220 to a bicycle. Although recesses 266, 268 are shown as closed threaded bores, the recesses 266, 268 can be provided as a through passage. The dial 234 and stem 254 can be offset from recesses 266, 268 along the longitudinally length of the mount body 222 in such a configuration.

A passage 6030 can be formed through mount body 222. A solenoid 6040 can be integrated into the mount body 222 such that a solenoid plunger 6050 of the solenoid 6040 acts as a valve gate in the passage 6030. The passage 6030 can selectively fluidly connect the second air volume 6020 and the third air volume 246 using the solenoid 6040 as a valve. Alternatively, the solenoid 6040 can be replaced with a mechanical valve such as a ball valve.

The shock 220 can include a second valve assembly 276 that can extend through the mount body 222 and can be fluidly connected to air volume 248. The second valve assembly 276 can allow a user to pressurize air chamber 246 so as to provide a desired spring performance over an initial travel of the shock 220. Once the cylinder 228 has translated an amount sufficient to compress the gas of volume 248 to a value that is approximately the pressurization of volume 250, volumes 248, 250 collectively contribute to the spring performance of shock 220. Such a construction enhances the range of desired suspension characteristics that can be achieved with shock 220. Similar to shock 40, replacing cap 226 with a cap having a volume other than that shown also alters the spring performance of shock 220. As cap 226 is positioned outboard of the locations that shock 220 is secured to the structure of bicycle 30, i.e. not between eyelet 148 and mount body 222, cap 226 can readily be replaced without otherwise altering the mounting of shock 220 to bicycle 30.

During a first mode (a dual rate control valve mode), the solenoid 6040 can be configured to isolate the third air volume 246 and the second air volume 6020 during a first translation range of the cylinder 228 into the sleeve 224 and can be configured to fluidly couple the third air volume 246 and the second air volume 6020 during a second translation range of the cylinder 228 into the sleeve 224. For example, the first translation range can be the first half of the translation of the cylinder 228 into the sleeve 224 and the second translation range can be the second half of the translation of the cylinder 228 into the sleeve 224. During the first translation range, the solenoid plunger 6050 can block the passage 6030, isolating the third air volume 246 and the second air volume 6020. During the second translation range, the solenoid plunger 6050 opens the passage 6030, fluidly connecting the third air volume 246 and the second air volume 6020, eventually coupling to the first air volume 6010, as described above. Hence, the third air volume 246 and the second air volume 6020 can be isolated during the first half of the translation of the cylinder 228 into the sleeve 224 and the third air volume 246 and the second air volume 6020 can be fluidly coupled during the second half of the translation of the cylinder 228 into the sleeve 224. In the first mode, during the first translation range 1722, the third air volume 246 springs the shock 220; but, during the second translation range 1727, the third air volume 246, the second air volume 6020, and the first air volume 6010 spring the shock 220. Advantageously, in the first mode, during small compressions of the shock 220, the third air volume 246 can work alone resulting in a crisp spring response; but, during deep compressions, the third air volume 246, the second air volume 6020, and the first air volume 6010 can work together resulting in a plush spring response during deep hits.

During a second mode (an active climb mode), the solenoid 6040 can be configured to be always open or partially open. Thus, the third air volume 246 and the second air volume 6020 are fluidly coupled by the solenoid 6040 during both the first translation range and the second translation range 1727. Thus, in second mode, the third air volume 246, the second air volume 6020, and the first air volume 6010 spring the shock 220. Advantageously, in the second mode, during a climb, a sag of the shock 220 is reduced resulting in a stiffer, thus, easier climb for the rider.

In another embodiment, during a third mode, the solenoid 6040 can be configured to be always closed. Thus, the third air volume 246 and the second air volume 6020 are isolated by the solenoid 6040 during both the first translation range and the second translation range 1727. Thus, in third mode, the third air volume 246 springs the shock 220.

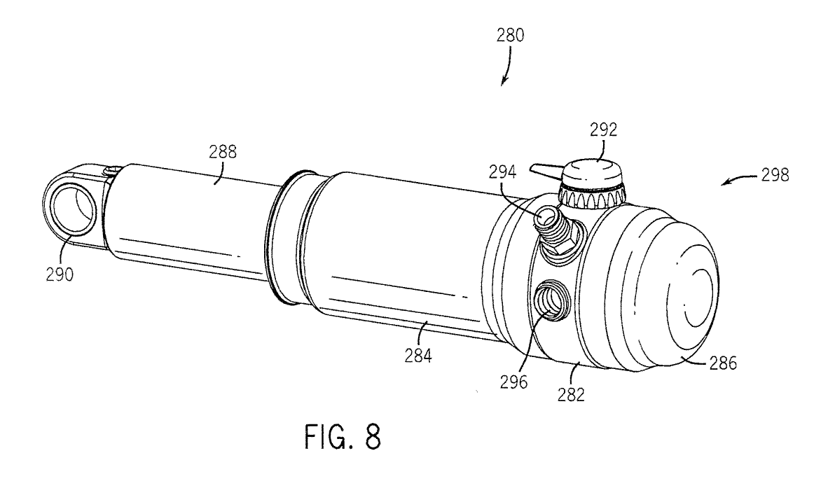

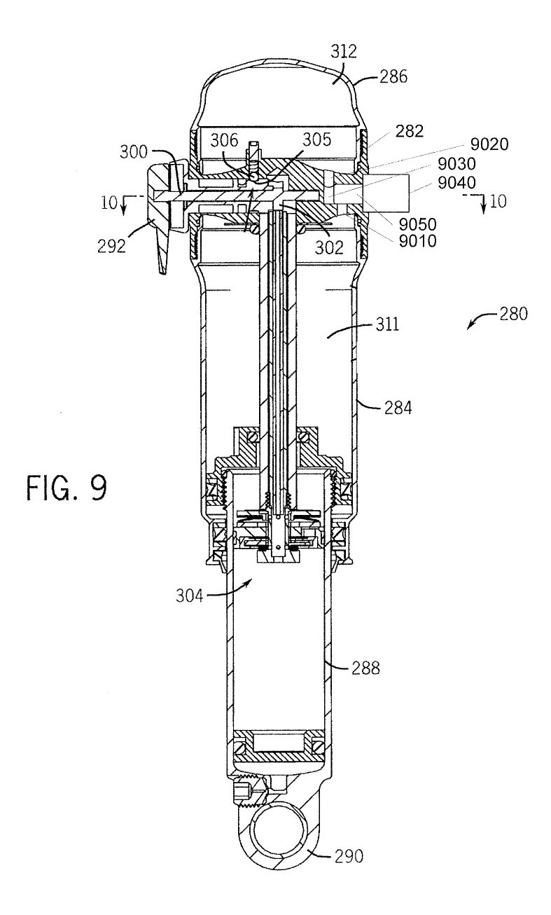

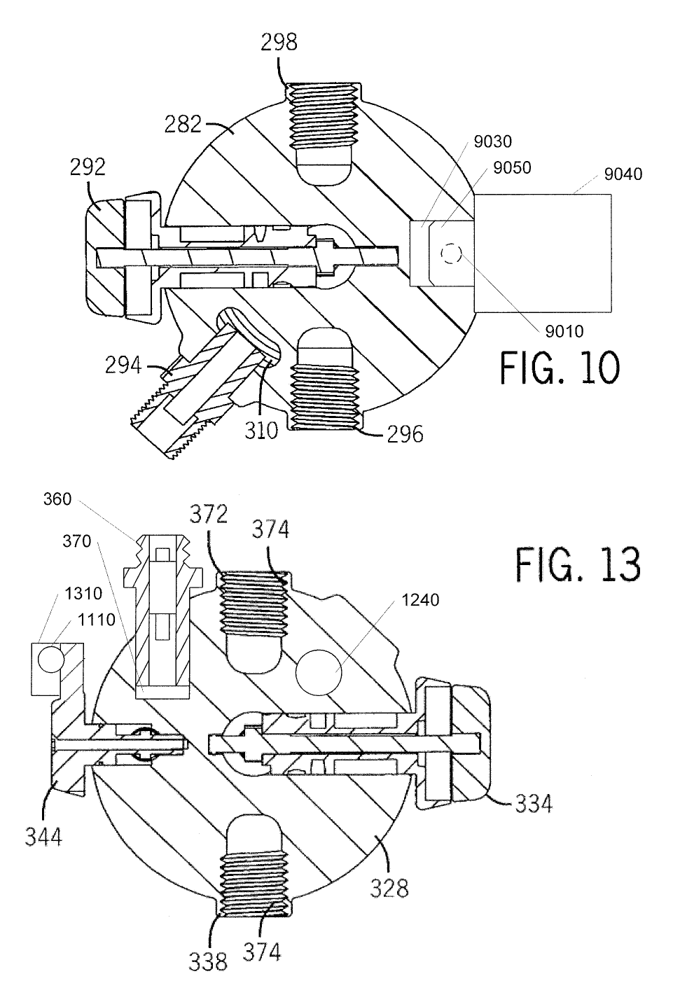

FIGS. 8-10 show a shock assembly or shock 280 in accordance with another illustrative embodiment. Referring to FIG. 8, a side view of the shock 280 in accordance with an illustrative embodiment is shown. Referring to FIG. 9, a section side view of the shock 280 of FIG. 8 in accordance with an illustrative embodiment is shown. Referring to FIG. 10, a section view of a mount body 282 of FIG. 8 in accordance with an illustrative embodiment is shown.

The construction of shock 280 is generally similar to shock 220. Shock 280 can includes the mount body 282 disposed between a sleeve 284 and a replaceable cap 286. A cylinder 288 can be slidably received in sleeve 284 and can include an eyelet 290 located at an end thereof. The mount body 282 can include an operator or dial 292, a valve assembly 294, and a pair of recesses 296, 298 positioned on generally opposite sides of mount body 282. A stem 300 can extend from the dial 292 and can include a cam 302 that can operatively interact in an offset manner with a valve assembly 304 associated with the cylinder 288. The stem 300 can include a number of detents 305 that cooperate with a ball 306 to provide a tactile or audible indication of the position of the dial 292 and thereby indicate an operating orientation of the valve assembly 304. A passage 310 can be formed into mount body 282 to fluidly connect a volume 311 enclosed by sleeve 284 to a fill valve 294.

The recesses 296, 298 can be threaded to cooperate with a fastener such that mount body 282 can be secured to a bicycle. A user, desiring to alter the performance of shock 280, can replace cap 286 with a cap that encloses a volume associated with a desired suspension characteristic. Positioning cap 286 outboard of the recesses 296, 298 of shock 280, allows a user to easily replace the cap 286 without remove shock 280 from a bicycle.

The shock 280 can include a first volume 311 formed by the sleeve 284, the mount body 282, and the cylinder 288. The first volume 311 can be a gas chamber configured to contain a pressurized gas such as air or nitrogen. The shock 280 can include a second volume 312 formed by the mount body 282 and the cap 286. The second volume 312 can be a gas chamber configured to contain a pressurized gas such as air or nitrogen. The cap 286 can removably cooperate with mount body 282 such that caps having other sizes and/or shapes can be connected to mount body 282. Altering the size and/or shape of cap 286 alters the volume of the second volume 312. Altering the volume of the second volume 312 can alter the air spring performance of shock 280.

A valving channel 9030 can be formed into mount body 282. A first passage 9010 can be formed between the valving channel 9030 and the first volume 311. A second passage 9020 can be formed between the valving channel 9030 and the second volume 312. A solenoid 9040 can be attached to the mount body 282 such that a solenoid plunger 9050 can translate in the valving channel. The valving channel 9030 can selectively fluidly connect the first volume 311 and the second volume 312 using the solenoid plunger 9050 as a valve. When the solenoid plunger 9050 is in a first position, the solenoid plunger 9050 covers the first passage 9010, isolating the first volume 311 and the second volume 312. When the solenoid plunger 9050 is in a second position, the solenoid plunger 9050 does not cover the first passage 9010, fluidly connecting the first volume 311 and the second volume 312 via first passage 9010 and the second passage 9020.

During a first mode (a dual rate control valve mode), the solenoid 9040 can be configured to isolate the first volume 311 and the second volume 312 during a first translation range of the cylinder 288 into the sleeve 284 and can be configured to fluidly couple the first volume 311 and the second volume 312 during a second translation range of the cylinder 288 into the sleeve 284. For example, the first translation range can be the first half of the translation of the cylinder 288 into the sleeve 284 and the second translation range can be the second half of the translation of the cylinder 288 into the sleeve 284. During the first translation range, the solenoid plunger 9050 can block the valving channel 9030, isolating the first volume 311 and the second volume 312. During the second translation range, the solenoid plunger 9050 opens the valving channel 9030, fluidly connecting the first volume 311 and the second volume 312.

Hence, the first volume 311 and the second volume 312 can be isolated during the first half of the translation of the cylinder 288 into the sleeve 284 and the first volume 311 and the second volume 312 can be fluidly coupled during the second half of the translation of the cylinder 288 into the sleeve 284. In the first mode, during the first translation range 1722, the first volume 311 springs the shock 280; but, during the second translation range 1727, the first volume 311 and the second volume 312 spring the shock 280. Advantageously, in the first mode, during small compressions of the shock 280, the first volume 311 can work alone resulting in a crisp spring response; but, during deep compressions, the first volume 311 and the second volume 312 can work together resulting in a plush spring response during deep hits.

During a second mode (an active climb mode), the solenoid 9040 can be configured to be always open or partially open. Thus, the first volume 311 and the second volume 312 are fluidly coupled by the solenoid 9040 during both the first translation range and the second translation range 1727. Thus, in second mode, the first volume 311 and the second volume 312 spring the shock 280. Advantageously, in the second mode, during a climb, a sag of the shock 280 is reduced resulting in a stiffer, thus, easier climb for the rider.

In another embodiment, during a third mode, the solenoid 9040 can be configured to be always closed. Thus, the first volume 311 and the second volume 312 are isolated by the solenoid 9040 during both the first translation range and the second translation range 1727. Thus, in third mode, the first volume 311 springs the shock 280.

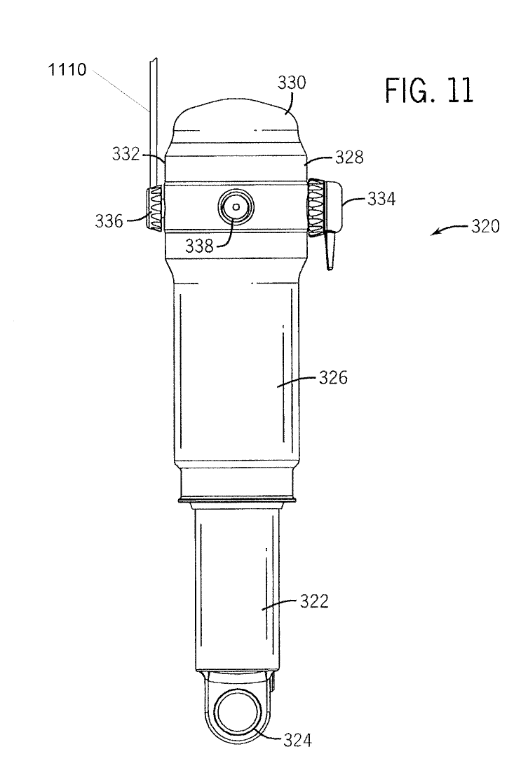

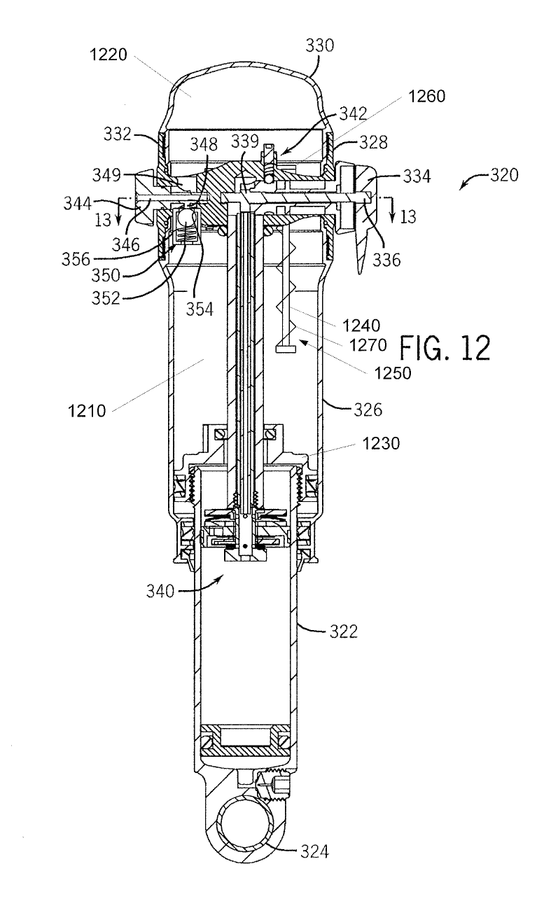

FIGS. 11-13 show a shock assembly or shock 320 in accordance with another illustrative embodiment. Referring to FIG. 11, a side view of the shock 320 in accordance with an illustrative embodiment is shown. Referring to FIG. 12, a section side view of the shock 320 of FIG. 11 in accordance with an illustrative embodiment is shown. Referring to FIG. 13, a section view of a mount body 328 of FIG. 11 in accordance with an illustrative embodiment is shown.

The shock 320 can include a cylinder 322 having an eyelet 324 positioned at one end thereof. The cylinder 322 can slidably cooperates with a sleeve 326 that can be attached to a mount body 328. A cap 330 can be attached to an end 332 of the mount body 328 generally opposite the sleeve 326. The shock 320 can include a first operator or dial 334 that can be oriented and constructed generally similar to dial 292 of shock 280. A shaft 336 can extend from the dial 334 into the mount body 328 and has a cam 339 formed thereon. Manipulation of the dial 334 can alter the configuration of a valve assembly 340 associated with the fluid chamber of cylinder 322. An indicator assembly 342 can interact with dial 334 to provide an audible or tactile indication of the position of the dial 334 and thereby an indication of the setting of the valve assembly 340.

The shock 320 can include a second operator or dial 344 that is also attached to mount body 328. A stem 346 can extend from the dial 344 and include a cam 348 formed thereon. A passage 349 can be formed through mount body 328 proximate to the cam 348. Passage 349 can fluidly connect a first gas volume 1210 and a second gas volume 1220. The first gas volume 1210 can be defined by the sleeve 326, the mount body 328, and a piston cap 1230 of the cylinder 322. The first gas volume 1210 can be defined by the cap 330 and the mount body 328. The mount body 328 can include a valve assembly 350 that interrupts passage 349 and cooperates with the cam 348. The valve assembly 350 can include a ball 352 that cooperates with a seat 354 associated with mount body 328. A spring 356 can be disposed in the valve assembly 350 and can bias the ball 352 into the seat 354. The cam 348 can cooperate with the spring 356 in such a manner that a user can push the ball 352 off of the seat 354 via manipulation of dial 344. The dial 344 can allow a user to alter the gap between the ball 352 and the seat 354. In one embodiment, the dial 344 can be manipulated by a cable 1110 attached to the dial 344 with a clamp 1310. The cable 1110 can be run to a lever or switch on, for example, a handlebar of a bicycle.

The mount body 328 can also include a plunger valve 1240. The plunger valve 1240 can fluidly connect the first gas volume 1210 and the second gas volume 1220. The plunger valve 1240 can be, for example, a Schrader valve. The plunger valve 1240 can include a plunger 1250, a plunger seat 1260, and a plunger spring 1270. The plunger 1250 can extend into the first gas volume 1210. In one embodiment, the plunger valve 1240 can be opened when the piston cap 1230 of the cylinder 322 strikes the plunger 1250, thereby compressing the plunger spring 1270 and pushing the plunger 1250 off of the plunger seat 1260. In one embodiment, the plunger 1250 can extend halfway into the first gas volume 1210; thus, the plunger valve 1240 can open when the piston cap 1230 has translated halfway through the sleeve 326. In other embodiments, the plunger 1250 can be any other length or adjustable.

The mount body 328 can include a valve assembly 360 that can be fluidly connected to the volume enclosed by sleeve 326. An opening 370 is formed through mount body 328 proximate valve assembly 360 and fluidly connected to the volume enclosed by sleeve 326. The valve assembly 350 can be opened so that the first gas volume 1210 and the second gas volume 1220 can be pressurized.

The mount body 328 of shock 320 can include a recess 372 that is positioned generally opposite a recess 338. The recesses 338, 372 can include a number of threads 374 that can cooperate with fasteners for securing shock 320 to corresponding structure of a bicycle.

During a first mode (a dual rate control valve mode), the valve assembly 350 can be closed. However, in the first mode the plunger valve 1240 can be configured to isolate the first volume 1210 and the second volume 1220 during a first translation range of the cylinder 322 into the sleeve 326 and can be configured to fluidly couple the first volume 1210 and the second volume 1220 during a second translation range of the cylinder 322 into the sleeve 326. For example, the first translation range can be the first half of the translation of the cylinder 322 into the sleeve 326 and the second translation range can be the second half of the translation of the cylinder 322 into the sleeve 326. During the first translation range, plunger valve 1240 can be closed, isolating the first volume 1210 and the second volume 1220. During the second translation range, the plunger valve 1240 opens when the piston cap 1230 of the cylinder 322 strikes the plunger 1250, fluidly connecting the first volume 1210 and the second volume 1220. Hence, the first volume 1210 and the second volume 1220 can be isolated during the first half of the translation of the cylinder 322 into the sleeve 326 and the first volume 1210 and the second volume 1220 can be fluidly coupled during the second half of the translation of the cylinder 322 into the sleeve 326. In the first mode, during the first translation range 1722, the first volume 1210 springs the shock 320; but, during the second translation range 1727, the first volume 1210 and the second volume 1220 spring the shock 320. Advantageously, in the first mode, during small compressions of the shock 320, the first volume 1210 can work alone resulting in a crisp spring response; but, during deep compressions, the first volume 1210 and the second volume 1220 can work together resulting in a plush spring response during deep hits.

During a second mode (an active climb mode), the valve assembly 350 can be configured to be always open or partially open, for example, by turning the dial 344. Thus, the first volume 1210 and the second volume 1220 are fluidly coupled by the valve assembly 350 during both the first translation range and the second translation range 1727. Notably, the plunger valve 1240 continues to operate as described above. Thus, in second mode, the first volume 1210 and the second volume 1220 spring the shock 320. Advantageously, in the second mode, during a climb, a sag of the shock 320 is reduced resulting in a stiffer, thus, easier climb for the rider.

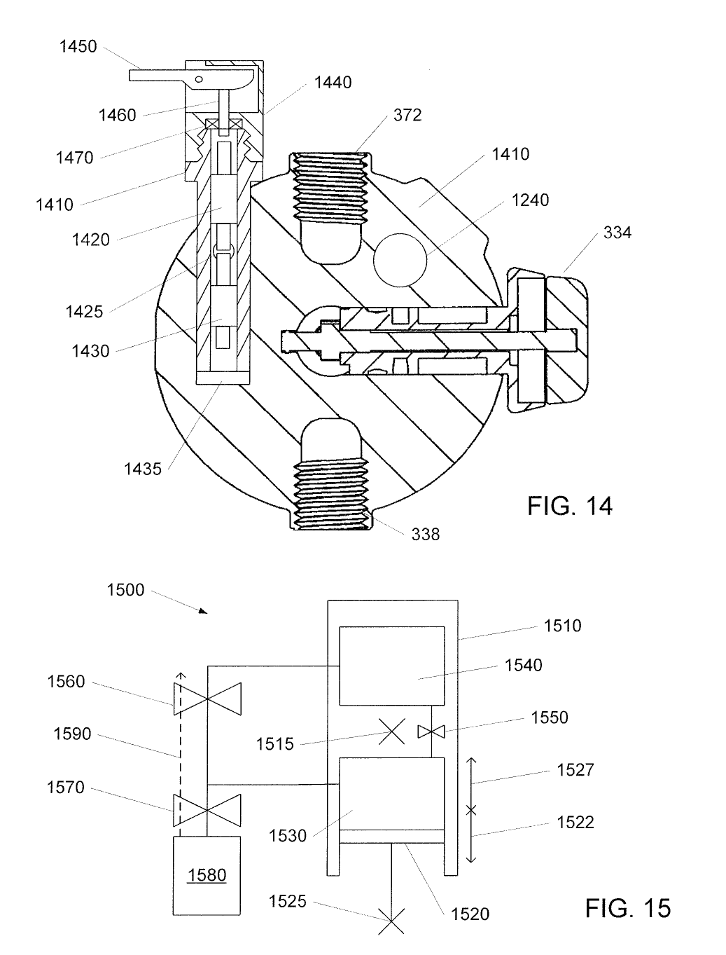

Referring to FIG. 14, a section view of an alternate mount body 1410 of the shock 32 of FIG. 11 in accordance with an illustrative embodiment is shown. The alternate mount body 1410 can include the dial 334 for configuring the valve assembly 340, the recesses 338, 372, and the plunger valve 1240. The alternate mount body 1410 can also include a fill valve 1415. The fill valve 1415 can include a first valve 1420 and a second valve 1430. The first valve 1420 and the second valve 1430 can be, for example, Schrader valves. The alternate mount body 1410 can include a first passage 1425 that fluidly couples the fill valve 1415 to the first volume 1210. The first passage 1425 can be located between the first valve 1420 and the second valve 1430. The alternate mount body 1410 can include a second passage 1435 that fluidly couples the fill valve 1415 to the second volume 1220. The first passage 1425 can be located after the second valve 1430. When the first valve 1420 is open to a first position, the fill valve 1415 can be fluidly coupled to the first volume 1210. When the first valve 1420 is open to a second position, the second valve 1430 can be opened by the first valve 1420, and the fill valve 1415 can be fluidly coupled to the first volume 1210 and the second volume 1220.

An adapter cap 1440 can be attached to the fill valve 1415. The adapter cap 1440 can include a lever 1450, a pin 1460, and a seal 1470. The pin 1460 can be configured so that when the adapter cap 1440 is attached to the fill valve 1415, the pin 1460 can activate the first valve 1420. For example, the pin 1460 can strike or push in a pin of the first valve 1420. The seal 1470 can seal the adapter cap 1440 to the fill valve 1415 and seal the pin 1460. Thus, the adapter cap 1440 can be configured to prevent the shock 320 from depressurizing. The lever 1450 can be configured to push in the pin 1460 or release the pin 1460. In a closed position, the lever 1450 does not activate the first valve 1420 and, thus, the second valve 1430 is not activated. In an open position, the lever 1450 can activate the first valve 1420 and, thus, the second valve 1430 can also be activated. In another embodiment, the pin 1460 can be spring loaded.

During the first mode (a dual rate control valve mode), the lever 1450 can be in an closed position; thus, the first valve 1420 and the second valve 1430 can be closed. In the first mode, the plunger valve 1240 can operate at described above. The lever 1450 can be configured to not push in the pin 1460 and, thus, the pin 1460 does not push in the pin of the first valve 1420 and, consequently, a pin of the second valve 1430 is not pushed in. Hence, the first volume 1210 and the second volume 1220 can be isolated during a first translation range of the cylinder 322 into the sleeve 326, and the first volume 1210 and the second volume 1220 can be fluidly coupled during a second translation range of the cylinder 322 into the sleeve 326.

During the second mode (an active climb mode), the lever 1450 can be in an open position; thus, the first valve 1420 and the second valve 1430 can be always open or partially open. In the second mode, the plunger valve 1240 can still operate at described above. Thus, the first volume 1210 and the second volume 1220 are fluidly coupled by the fill valve 1415 during both the first translation range and the second translation range 1727. Notably, the seal 1470 can prevent the shock 320 from depressurizing during the second mode.

Multi-Mode Electronic Seat Post

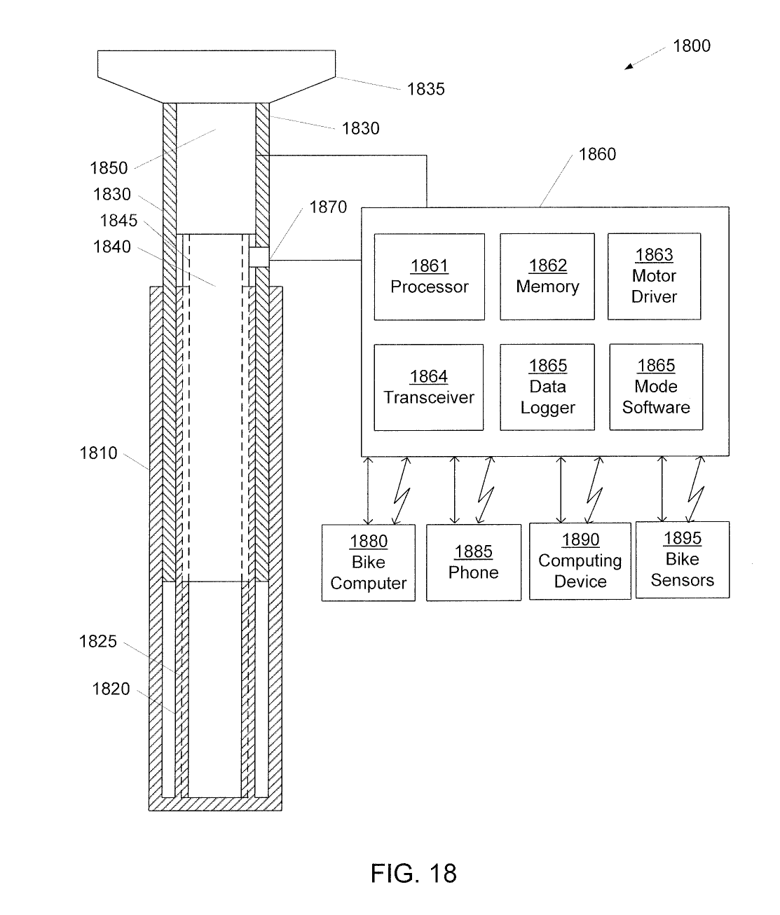

Referring to FIG. 18, a section view of a seat post 1800 in accordance with an illustrative embodiment is shown. The seat post 1800 can include an outer tube 1810, an inner tube 1820, a stanchion 1830, a jackscrew 1840, a motor 1850, and a saddle mount 1835. The saddle mount 1835 can be attached to the stanchion 1830. The motor 1850 can be located in the stanchion 1830, for example, next to the saddle mount 1835. The jackscrew 1840 can be attached to a driveshaft of the motor 1850. Thus, when the driveshaft of the motor 1850 spins, the jackscrew 1840 spins. The jackscrew 1840 can include jackscrew threads 1845.

The inner tube 1820 can be fixed in the outer tube 1810. The outer tube 1810 can be configured as a 77.7 mm seat post. The inner tube 1820 can include inner tube threads 1825. The inner tube threads 1825 can mate with the jackscrew threads 1845. The jackscrew 1840 can be threaded into the inner tube 1820 such that the stanchion 1830 can move in the outer tube 1810. In one embodiment, the stanchion 1830 can travel in a space between the inner tube 1820 and the outer tube 1810. Hence, motor 1850 can cause the stanchion 1830 and the outer tube 1810 to extend or contract by turning the jackscrew 1840. In one embodiment, hydraulic fluid in the inner tube 1820 can be used to lock or assist the jackscrew 1840.

The motor 1850 can be controlled by a controller 1860. The controller 1860 can include one or more of, a processor 1861, a memory 1862, data logging software 1865, mode software 1866, a motor driver 1863, a display, a user interface, and a transceiver 1763. In alternative embodiments, the controller 1860 may include fewer, additional, and/or different components. The memory 1862, which can be any type of permanent or removable computer memory known to those of skill in the art, can be a computer-readable storage medium. The memory 1862 can be configured to store one or more of the data logging software 1865, mode software 1866, rebound software 1766, pedal stiffness software 1766, an application configured to run the software 1865, 1866, 1766, and 1767, capture data, and/or other information and applications as known to those of skill in the art. The transceiver 1763 can be used to receive and/or transmit information through a wired or wireless network as known to those of skill in the art. The transceiver 1763, which can include a receiver and/or a transmitter, can be a modem or other communication component known to those of skill in the art. In another embodiment, the controller 1860 can also control additional motor and/or valves of the seat post 1800. In one embodiment, the controller 1860 can also control a hydraulic valve and/or a hydraulic pump configured to assist and/lock the jackscrew 1840.

The controller 1860 can be communicatively connected, wired or wirelessly, to a position sensor 1870 or any other sensor. The position sensor 1870 can be configured to sense the translation of the stanchion 1830 into the outer tube 1810. The position sensor 1870 can be, for example, a Hall effect sensor, a capacitive sensor, an inductive sensor, a proximity sensor, an encoder, a resolver, a resistive position sensor, an opto-electronic sensor, or any other type of sensor. The position sensor 1791 can be located, for example, in the stanchion 1830 next to the jackscrew 1840. In one embodiment, the position sensor 1870 can be a Hall effect sensor and the Hall effect sensor can count teeth formed into a portion of the jackscrew 1840.

The controller 1860 can also be communicatively connected, wired or wirelessly, to a bike computer 1880, a phone 1885, a computing device 1890, and other bike sensors 1895. The bike computer 1880 can be, for example, a small interface for displaying and tracking the performance of a bike and a rider. In one embodiment, the controller 1860 can send and receive data to and from the bike computer 1880. For example, the rider can use the bike computer 1880 to instruct the controller 1860 to change from a first mode to a second mode. The phone 1885 can be, for example, a smart phone such as an iPhone™ available from Apple Computer Corp., Cupertino, Calif., or an Android™-type phone available various suppliers such Motorola Corp., Schaumberg, Ill. The phone 1885 can, for example, be attached to the handlebar of a bicycle. The phone 1885 can, for example, include software, such as an application, that provides an interface for the controller 1860 and the rider. In one embodiment, the controller 1860 can send and receive data to and from the phone 1885. For example, the rider can use the phone 1885 to instruct the controller 1860 to change from the first mode to the second mode. The computing device 1890 can be a personal computer, a laptop, or any other kind of computer. The computing device 1890 can, for example, include software, such as an application, that provides an interface for the controller 1860 and the rider. In one embodiment, the controller 1860 can send and receive data to and from the computing device 1890. For example, the rider can use the computing device 1890 to instruct the controller 1860 to send performance data of the seat post 1800.

The bike sensors 1895 can be sensors located on the bike, for example, an accelerometer, a gyroscope, a global positioning system (GPS) sensor, or any other sensor. The controller 1860 can send and receive data to and from the bike sensors 1895. For example, the controller 1860 can collect multi-dimensional acceleration information from the bike sensors 1895.

The data logging software 1865 can be configured to collect and condition sensor and seat post data. For example, data from the position sensor 1791 can be stored in memory 1862. Likewise, the data logging software 1865 can record the mode and state of the motor 1850 and seat post 1800.

The mode software 1866 can be configured to set the mode of the seat post 1800. In one embodiment, the mode software 1866 can extend or contract the stanchion 1830 and the outer tube 1810 based on the mode and the position of the stanchion 1830 relative to the outer tube 1810. For example, the mode software 1866 can receive a command from the rider to place the seat post 1800 into the first mode (descend mode). The mode software 1866 can then control the motor 1850 to contract (lower) the seat post 1800 during a descent and extend (raise) the seat post 1800 when the bike is level. The mode software 1866 can determine the optimal mode for the rider based on sensor information. For example, the mode software 1866 can receive accelerometer data and determine that the rider is pedaling downhill. The mode software 1866 can automatically contract the seat post 1800. In a second mode, the seat post 1800 can be in a fixed position. In another embodiment, the mode software 1866 can be configured to set the seat post 1800 at various levels depending on sensed terrain conditions. For example, the mode software 1866 can include a third mode where the seat post 1800 can be raised and lowered automatically depending on the particular technical terrain conditions. The mode software 1866 can also accept a manual extend and contract commands from a rider using, for example, any of the bike computer 1880, the phone 1885, and the computing device 1890.

In one embodiment, the data logging software 1865 and mode software 1866 can include a computer program such as C++ or Java and/or an application configured to execute the program. Alternatively, other programming languages and/or applications known to those of skill in the art can be used. In one embodiment, the data logging software 1865 and mode software 1866 can be a dedicated standalone application. The processor 1861, which can be in electrical communication with each of the components of the multiple mode shock system 1700, can be used to run the application and to execute the instructions of the data logging software 1865 and mode software 1866. Any type of computer processor(s) known to those of skill in the art may be used.

Multi-Mode Electronic Fork

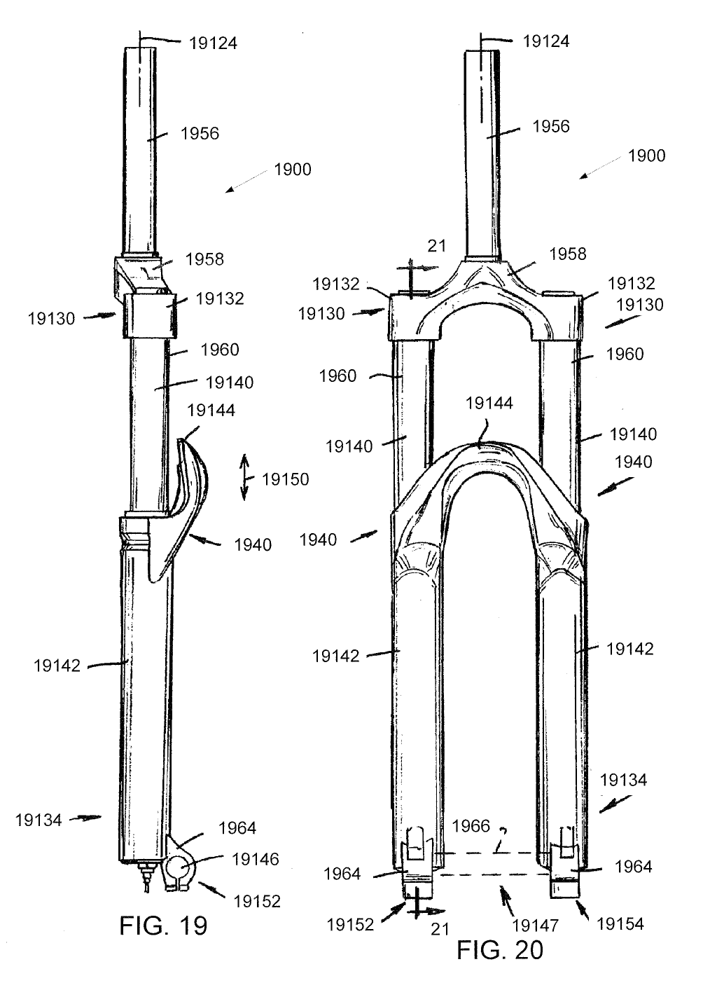

Referring to FIG. 19, a side view of a bicycle fork 1900 in accordance with an illustrative embodiment is shown. Referring to FIG. 20, a front view of the bicycle fork 1900 of FIG. 19 in accordance with an illustrative embodiment is shown. A more complete description of some aspects of bicycle fork 1900 can be found in U.S. application Ser. No. 12/484,595, filed Jun. 15, 2009, which is incorporated by reference in its entirety. Referring to FIGS. 19 and 20, the bicycle can include two shock assemblies 1940 that are each secured to fork crown 1958 such that shock assemblies 1940 can form the forks 1960 of the bicycle. A first end 19130 of each shock assembly 1940 can be secured to a respective shoulder or arm 19132 of fork crown 58. A second end 19134 of each shock assembly 1940 can form fork tip 1964 of each shock assembly. The stem 1956 can be generally centrally positioned with respect to the longitudinal axis of each fork assembly 40. The stem 1956 can form a steerer tube and extend from fork crown 1958 in a direction generally opposite shock assemblies 40. The stem 1956 can engage frame 1932 of the bicycle such that rotation of stem 1956 about a longitudinal axis 19124 of stem 1956 rotates forks 1960 about axis 19124 so as to steer the bicycle.

Each shock assembly 1940 can include a first sleeve, tube, or cap tube 19140 that can cooperate with a second sleeve, tube, or leg tube 142. Each cap tube 19140 and leg tube 19142 can be telescopically associated. An optional arch 19144 (see FIG. 20) can connect each leg tube 19142 of adjacent shock assemblies 1940 and define a wheel cavity 19146 between the adjacent forks 60. Each fork tip 1964 can include a dropout or opening 19147 that can receive a respective end 19152, 19154 of axle 1966. During loading and unloading of the wheel of the bicycle, cap tubes 19140 and leg tubes 19142 can translate relative to one another, indicated by arrow 99150, thereby altering the distance between fork tips 1964 and arms 19132 of fork crown 1958. Shock assemblies 1940 can absorb and dissipate a portion of the energy associated with an impact.

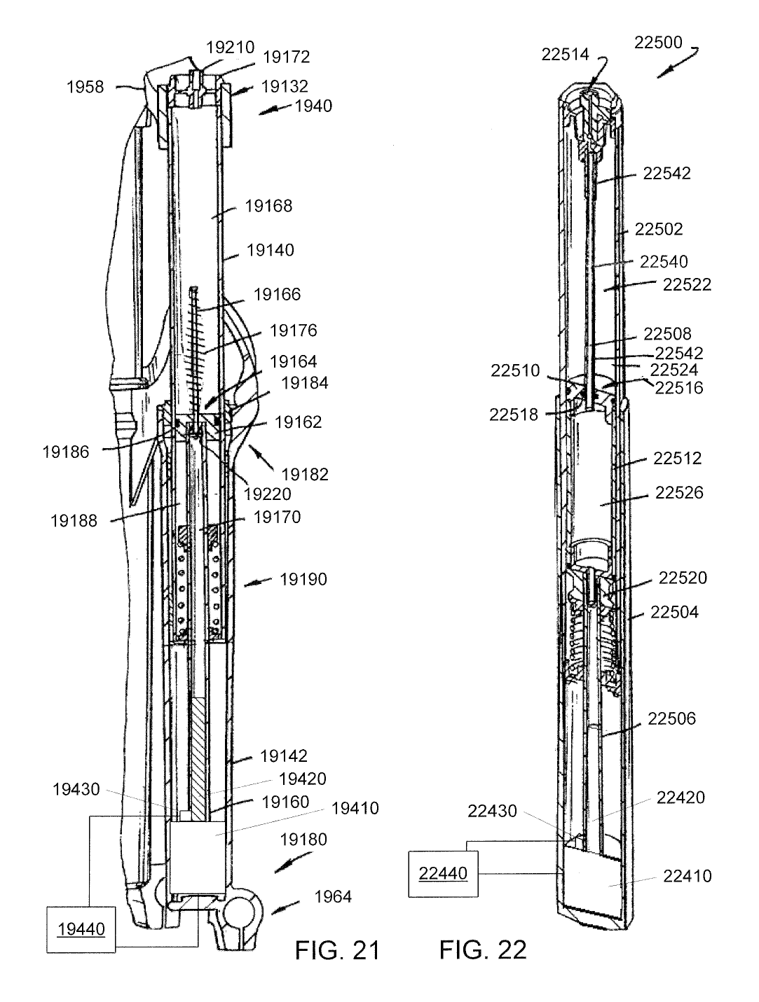

Referring to FIG. 21, a section view of the shock assembly 40 of FIG. 19 in accordance with an illustrative embodiment is shown. The shock assembly 1940 can include a cap tube 19140 that can slidably engage a leg tube 19142. A hollow stem or compression rod 19160 can extend longitudinally along the leg tube 19142 and include a piston 19162 that can be supported at an end thereof. A moveable valve 19164 can be foamed through piston 19162 and selectively separate a volume generally above the piston and a volume enclosed by the compression rod.

Each shock assembly 1940 can include a skewer or plunger 19166 that can be aligned with valve arrangement, valve assembly, or valve 19164 so as to selectively fluidly connect a first cavity or chamber 19168 and a second cavity or chamber 19170 of each shock assembly 1940. The first chamber 19168 and the second chamber 19170 can be selectively fluidly connected/separated by valve 19164 that can be supported by piston 19162. The first chamber 19168 can be generally defined as the area or volume enclosed by cap tube 19140, piston 19162, and a cap tube cap 19172. The cap tube 19140 and cap tube cap 19172 can be formed as a unitary tube having one closed end. The cap tube cap 19172 can be formed integrally with the body of cap tube 19140. The second chamber 19170 can be defined as the area generally enclosed by compression rod 19160 and the valve 19164 supported by piston 19162.

A spring 19176 can bias valve 19164 to a closed position so as to fluidly separate first chamber 19168 from second chamber 19170. Upon a designated displacement of dropouts 1964 relative to arm 19132 of fork crown 1958, plunger 19166 can interact with other structures of shock assembly 1940 such as the structure associated with tube cap 19172 and/or interacts with valve 19164 such that first chamber 19168 and second chamber 19170 can be fluidly connected to one another such that second chamber 19170 contributes to the performance of shock assembly 1940 when valve 19164 is open.

The compression rod 19160 can offset piston 19162 from a first end 19180 of leg tube 19142 of shock assembly 1940. Cap tube 19140 can be slidably positioned between piston 19162 and leg tube 19142. A seal 19184 can be positioned between the interface of cap tube 19140 and leg tube 19142 proximate a second end 19182 of leg tube 19142. A piston seal 19186 can be disposed between piston 19162 and an interior surface 19188 of cap tube 19140. During shortening of the overall length of the shock assembly 1940, piston 19162 compresses the gas contained in first chamber 19168 of shock assembly 1940 thereby resisting or absorbing a portion of the energy associated with the compression stroke of the shock assembly. A bumper assembly 19190 can be disposed between piston 19162 and dropout 1964 and dampens motion as shock assembly 1940 approaches a fully lengthened orientation during recovery from aggressive compressions.

The plunger 19166 can extend from valve 19164. Plunger 19166 can pass through an opening in piston 19162 and extend longitudinally along first chamber 19168 toward tube cap 19172. The plunger 19166 can include a stop, lip, or head portion that is sized to contain spring 19176 generally between the head portion and an upper surface or face of piston 19162. Spring 19176 can normally bias valve 19164 closed thereby fluidly separating first chamber 19168 from second chamber 19170.

During compression loading of shock assembly 1940, piston 19162 can translate to a position nearer arm 19132 and compress the volume of gas contained in first chamber 19168. At a selected distance, indicated by arrow 19202, plunger 19166 contacts tube cap 19172 of shock assembly 1940. Continued translation of piston 19162 in an upward direction toward tube cap 19172 translates plunger 19166, opening valve 19164. As valve 19164 opens, gas compressed in first chamber 19168 via the displacement of piston 19162 relative to tube cap 19172 can pass through valve 19164 and flows into second chamber 19170. Accordingly, when valve 19164 is opened, first chamber 19168 and second chamber 19170 both contribute to the operating performance of shock 1940. Until valve 19164 opens, of first and second chambers 19168, 19170, only first chamber 19168 contributes to the performance of shock assembly 1940 as second chamber 19170 maintains a fixed shape and is fluidly isolated from first chamber 19168.

The shock assembly 1940 can include a fill valve 19210 that is supported by tube cap 19172. The fill valve 19210 can be a Schrader valve. The fill valve 19210 can fluidly separate first chamber 19168 from atmosphere. During initial configuration of shock assembly 1940, first chamber 19168 can be pressurized to a desired value via fill valve 19210. After an oscillation of shock assembly 1940 that is sufficient to open valve 19164 supported by piston 19162, first chamber 19168 and second chamber 19170 attain a pressure associated with compressing the at-rest volume of gas of first chamber 19168 to the combined volume of first chamber 19168 and second chamber 19170 when piston 19162 attains distance 19202. The overall performance of shock assembly 1940 can be tailored to a riders' preference via the initial pressurization of first chamber 19168. Additionally, regardless of the initial pressurization, shock assembly 1940 also avoids overly progressive performance or non-responsive operation of the shock assembly at nearer full displacements by physically altering the size of the useable volume of the shock assembly. That is, the addition of second chamber 19170 to the volume of first chamber 19168 at an intermediate shock length allows for greater utilization of the shock across a wider range of available displacement lengths.

The shock assembly 1940 can also include a motor 19410. The motor 19410 can be located at the first end 19180 of the leg tube 19142 of the shock assembly 1940. A screw 19420 can be attached to a driveshaft of the motor 19410. Thus, when the driveshaft of the motor 19410 spins, the screw 19420 turns.

The compression rod 19160 can include inner threads. The screw 19420 can mate with the threads of the compression rod 19160. The screw 19420 can be threaded into the compression rod 19160 such that the compression rod 19160 can move in the leg tube 19142. Hence, motor 1850 can cause the compression rod 19160 to extend or contract within the leg tube 19142 by turning the screw 19420. The motor 19410 can be controlled by a controller 19440 using a position sensor 19430. The controller 19440 and position sensor 19430 can be similar to the controller of FIG. 18.

In one embodiment, motor 1850 can cause the compression rod 19160 to extend or contract within the leg tube 19142 by 30 mm; however, any length is possible. Accordingly, a height of the bicycle fork 1900 can be altered, for example, by 30 mm. Advantageously, the height of the bicycle fork 1900 can be extended or contracted to assist the rider during climbs and descents.

Referring to FIG. 22, a section view of a shock assembly 22500 in accordance with an illustrative embodiment is shown. The shock assembly 22500 can include a top tube 22502, a bottom tube 22504, a compression rod 22506, a tube skewer or plunger 22508, a piston 22510, and a sleeve 22512. The plunger 22508 can extend from a fill valve assembly 22514 and can slidably cooperate with an opening 22516 formed in piston 22510. A seal 22518 can be disposed between piston 22510 and plunger 22508. The interaction between piston 22510, seal 22518, and plunger 22508 can provide a valved interaction between the respective chambers of the shock assembly.

The sleeve 22512 can be sealingly supported between piston 22510 and a sleeve base 22520 and can generally define a second chamber 22526 of shock assembly 22500. The plunger 22508 can include a bypass section 22522 that has a reduced cross-sectional area as compared to the remainder of the plunger 22508. The bypass section 22522 can be constructed to pass through opening 22516 of piston 22510 and cooperate with piston 22510 in a manner that allows fluid communication between a first chamber 22524 and the second chamber 22526 of shock assembly 22500. The bypass section 22522 can allow plunger 22508 to cooperate with piston 22510 in a non-sealing manner.

When the bypass section 22522 is positioned in opening 22516 of piston 22510, the plunger 22508 can loosely cooperate with seal 22518 thereby allowing fluid flow between first chamber 22524 and second chamber 22526 of shock assembly 22500. Opposite ends of bypass section 22522 can include swaged or transition portions 530 that provide guided interaction between plunger 22508 and seal 22518 of piston 22510 as bypass section 22522 passes through opening 22516.

The fill valve assembly 22514 can be selectively fluidly connected to a passage 22540 defined by a sidewall 22542 of plunger 22508. Gas introduced through fill valve assembly 22514 can be directed directly to second chamber 22526. During an initial oscillation of shock assembly 22500, as bypass section 22522 enters opening 22516 formed in piston 22510, a portion of the initial gas charge can pass into first chamber 22524. As top tube 22502 is allowed to extend away bottom tube 22504, a lower portion 22542 of plunger of plunger 22508 can interact with opening 22516 of piston 22510 and so as to fluidly isolate the first and second chambers 22524, 22526 of shock assembly 22500. Continued translation of the top tube 22502 in a direction away from bottom tube 22504 can allow the pressure of first chamber 22524 to continue to decrease while the pressure of second chamber 22526 is maintained at desired value.

During subsequent oscillation of shock assembly 22500, the volume of passage 22540 of plunger 22508 and second chamber 22526 can contribute to the spring performance of shock assembly 22500 only when top tube 22502 and bottom tube 22504 attain relative positions such that bypass section 22522 interacts with piston 22510 thereby allowing fluid connectivity between the first and second chambers 22524, 22526. The sleeve base 22520 includes a cavity that is shaped and positioned to generally cooperate with an end portion of the plunger 22508 as shock assembly 22500 approaches a fully compressed orientation. Such a construction can allow the volume of plunger 22508 to be selectively isolated from contributing to the nearly fully compressed spring performance of shock assembly 22500.

The shock assembly 22500 can also include a motor 22410. The motor 22410 can be located at the first end 22450 of the bottom tube 22504 of the shock assembly 22500. A screw 22420 can be attached to a driveshaft of the motor 22410. Thus, when the driveshaft of the motor 22410 spins, the screw 22420 turns.

The compression rod 22506 can include inner threads. The screw 22420 can mate with the threads of the compression rod 22506. The screw 22420 can be threaded into the compression rod 22506 such that the compression rod 22506 can move in the bottom tube 22504. Hence, motor 1850 can cause the compression rod 22506 to extend or contract within the bottom tube 22504 by turning the screw 22420. The motor 22410 can be controlled by a controller 22440 using a position sensor 22430. The controller 22440 and position sensor 22430 can be similar to the controller of FIG. 18.

In one embodiment, motor 1850 can cause the compression rod 22506 to extend or contract within the bottom tube 22504 by 30 mm; however, any length is possible. Accordingly, a height of the bicycle fork 1900 can be altered, for example, by 30 mm. Advantageously, the height of the bicycle fork 1900 can be extended or contracted to assist the rider during climbs and descents.

One or more flow diagrams may have been used herein. The use of flow diagrams is not meant to be limiting with respect to the order of operations performed. The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The foregoing description of illustrative embodiments has been presented for purposes of illustration and of description. It is not intended to be exhaustive or limiting with respect to the precise form disclosed, and modifications and variations are possible in light of the above teachings or may be acquired from practice of the disclosed embodiments. It is intended that the scope of the invention be defined by the claims appended hereto and their equivalents.

What is claimed is:

1. An apparatus comprising:
a first gas chamber comprising:
a sleeve including a first mounting point; and
a cylinder including a second mounting point;
a second gas chamber; and
a coupler configured to:
in a first mode:
isolate the first gas chamber and the second gas chamber during a first translation range of the cylinder into the sleeve; and
fluidly couple the first gas chamber to the second gas chamber during a second translation range of the cylinder into the sleeve; and
in a second mode:
fluidly couple the first gas chamber to the second gas chamber during at least the first translation range and the second translation range of the cylinder into the sleeve.

2. The apparatus of claim 1, wherein the coupler comprises a valve.

3. The apparatus of claim 2, wherein the valve is configured to be activated by a remote cable.

4. The apparatus of claim 1, wherein the coupler comprises a first valve and a second valve.

5. The apparatus of claim 1, wherein the coupler is closed during the first translation range and the coupler is open during the second translation range.

6. The apparatus of claim 1, wherein the coupler comprises a solenoid valve.

7. The apparatus of claim 1, further comprising a damping mechanism associated with the cylinder.

8. The apparatus of claim 7, wherein a piston of the damping mechanism is located inside the cylinder, and the piston divides the cylinder into a first damping chamber and a second damping chamber.

9. The apparatus of claim 1, wherein the second gas chamber comprises a removable cap.

10. The apparatus of claim 1, further comprising a controller configured to receive mode information and control the coupler based at least in part on the mode information.

11. An apparatus comprising:
a first gas chamber, wherein a volume of the first gas chamber is associated with a first mounting point of the first gas chamber and a second mounting point of the first gas chamber;
a second gas chamber; and
a first valve configured to:
isolate the first gas chamber and the second gas chamber during a first translation range of the first mounting point and the second mounting point; and
fluidly couple the first gas chamber to the second gas chamber during a second translation range of the first mounting point and the second mounting point; and
a second valve configured to:
when the second valve is activated, fluidly couple the first gas chamber to the second gas chamber during at least the first translation range and the second translation range of the first mounting point and the second mounting point.

12. The apparatus of claim 11, wherein the first valve comprises a solenoid.

13. The apparatus of claim 11, wherein the first valve comprises a plunger.

14. The apparatus of claim 11, wherein the first gas chamber comprises a sleeve associated with the first mounting point and a cylinder associated with the second mounting point.

15. The apparatus of claim 14, further comprising a damping mechanism associated with the cylinder.

16. The apparatus of claim 14, wherein the second gas chamber is defined at least in part by a removable cap and at least a portion of the sleeve, and the first mounting point is located between the first gas chamber and the second gas chamber.

17. The apparatus of claim 11, wherein a volume of the second gas chamber is fixed.

18. The apparatus of claim 11, further comprising a controller configured to receive mode information and control the first valve and the second valve based at least in part on the mode information.

19. An apparatus comprising:
a first gas chamber comprising:
a sleeve including a first mounting point; and
a cylinder including a second mounting point;
a second gas chamber with a fixed volume;
a valve configured with at least two valving sequences over a translation range of the cylinder into the sleeve and configured to operate using one of the at least two valving sequences.

20. The apparatus of claim 19, wherein further comprising a controller configured to receive valving sequence information and control the valve based at least in part on the valving sequence information.
